(19) United States
(12) Patent Application Publication
(10) Pub. No.: US 2026/0005992 A1
(43) Pub. Date: Jan. 1, 2026

(54) MESSAGE MERGING AND DISPLAYING METHOD AND APPARATUS, DEVICE, STORAGE MEDIUM, AND PRODUCT

(71) Applicant: TENCENT TECHNOLOGY (SHENZHEN) COMPANY LIMITED, Shenzhen (CN)

(72) Inventors: Jie JIANG, Shenzhen (CN); Ruimin HUANG, Shenzhen (CN)

(73) Assignee: TENCENT TECHNOLOGY (SHENZHEN) COMPANY LIMITED, Shenzhen (CN)

(21) Appl. No.: 19/321,483

(22) Filed: Sep. 8, 2025

Related U.S. Application Data
(63) Continuation of application No. PCT/CN2024/113614, filed on Aug. 21, 2024.

(30) Foreign Application Priority Data
Sep. 5, 2023 (CN) 202311140899.2

(51) Int. Cl. H04L 51/043; H04L 51/52

(52) U.S. Cl. CPC H04L 51/043; H04L 51/52

(57) ABSTRACT

A message merging and displaying method, apparatus, and computer-readable storage medium for optimizing chat interface presentation. The method displays n messages of a first media type on a chat interface, where n is a positive integer. Upon receiving an (n+1)th message of the same media type, the system evaluates whether the combined n+1 messages satisfy a merging display condition. When the condition is met, the n+1 messages of the first media type are merged into a single merged message, which is then displayed on the chat interface. This approach enables cleaner chat interfaces by automatically consolidating multiple messages of the same media type when appropriate merging conditions are satisfied.

### CROSS-REFERENCE TO RELATED APPLICATIONS

This application is a continuation application of International Application No. PCT/CN2024/113614 filed on Aug. 21, 2024 which claims priority to Chinese Patent Application No. 202311140899.2, filed with the China National Intellectual Property Administration on Sep. 5, 2023, the disclosures of each being incorporated by reference herein in their entireties.

### FIELD

The disclosure relates to the field of artificial intelligence, and a message merging method and apparatus, a device, a storage medium, and a product.

### BACKGROUND

With explosive development of Internet technologies, online social networking has gradually become a main way for the public to socialize.

In the related art, a user implements online one-to-one communication or one-to-many communication by using an application supporting a chat conversation. For example, users perform an online chat conversation by transmitting a multimedia message on a chat interface of the application supporting a chat conversation.

However, the users may transmit a large quantity of same or similar multimedia messages during communication on the chat interface. For example, the users transmit a plurality of same emojis for expressing a same emotion. The large quantity of same or similar multimedia messages may be overwritten on the chat interface at a high frequency. Consequently, a user that needs to query for other information cannot quickly position useful information.

### SUMMARY

Provided are a message merging and displaying method and apparatus, a device, a storage medium, and a program product, which can implement efficient chat interface organization through automatic message merging based on media type and merging conditions.

According to some embodiments, a message merging and displaying method, performed by a computer device, includes: displaying n messages of a first media type on a chat interface, wherein n is a positive integer; receiving an (n+1)th message of the first media type; merging, based on n+1 messages that includes the n messages and the (n+1)th message satisfying a merging display condition, the n+1 messages of the first media type into a merged message; and displaying the merged message on the chat interface.

According to some embodiments, a message merging and displaying apparatus, includes: at least one memory configured to store program code; and at least one processor configured to read the program code and operate as instructed by the program code, the program code including: displaying code configured to cause at least one of the at least one processor to display n messages of a first media type on a chat interface, wherein n is a positive integer; receiving code configured to cause at least one of the at least one processor to receive an (n+1)th message of the first media type; merging code configured to cause at least one of the at least one processor to merge, based on n+1 messages that includes the n messages and the (n+1)th message satisfying a merging display condition, the n+1 messages of the first media type into a merged message; and presentation code configured to cause at least one of the at least one processor to display the merged message on the chat interface.

According to some embodiments, a non-transitory computer-readable storage medium, storing computer code which, when executed by at least one processor, causes the at least one processor to at least: display n messages of a first media type on a chat interface, wherein n is a positive integer; receive an (n+1)th message of the first media type; merge, based on n+1 messages that includes the n messages and the (n+1)th message satisfying a merging display condition, the n+1 messages of the first media type into a merged message; and display the merged message on the chat interface.

### BRIEF DESCRIPTION OF THE DRAWINGS

To describe the technical solutions in some embodiments more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a structural block diagram of a computer system according to some embodiments.

FIG. 2 is a schematic flowchart of a message merging method according to some embodiments.

FIG. 3 is a flowchart of a message merging method according to some embodiments.

FIG. 4 is a schematic diagram of a chat interface according to some embodiments.

FIG. 5 is a schematic diagram of a chat interface according to some embodiments.

FIG. 6 is a schematic diagram of a chat interface according to some embodiments.

FIG. 7 is a schematic diagram of a chat interface according to some embodiments.

FIG. 8 is a flowchart of a message merging method according to some embodiments.

FIG. 9 is a flowchart of a message merging method according to some embodiments.

FIG. 10 is a flowchart of a message merging method according to some embodiments.

FIG. 11 is a flowchart of a message merging method according to some embodiments.

FIG. 12 is a schematic diagram of a chat interface according to some embodiments.

FIG. 13 is a schematic diagram of a chat interface according to some embodiments.

FIG. 14 is a schematic diagram of a chat interface according to some embodiments.

FIG. 15 is a flowchart of a message merging method according to some embodiments.

FIG. 16 is a schematic diagram of a chat interface according to some embodiments.

FIG. 17 is a flowchart of a message merging method according to some embodiments.

FIG. 18 is a schematic diagram of a setting page according to some embodiments.

FIG. 19 is a flowchart of a message merging method according to some embodiments.

FIG. 20 is a schematic diagram of a chat interface according to some embodiments.

FIG. 21 is a flowchart of a message merging method according to some embodiments.

FIG. 22 is a schematic diagram of a chat interface according to some embodiments.

FIG. 23 is a flowchart of a message merging method according to some embodiments.

FIG. 24 is a schematic diagram of a chat interface according to some embodiments.

FIG. 25 is a flowchart of a message merging method according to some embodiments.

FIG. 26 is a schematic diagram of a chat interface according to some embodiments.

FIG. 27 is a flowchart of a message merging method according to some embodiments.

FIG. 28 is a flowchart of a message merging method according to some embodiments.

FIG. 29 is a flowchart of a message merging method according to some embodiments.

FIG. 30 is a flowchart of a message merging method according to some embodiments.

FIG. 31 is a flowchart of a message merging method according to some embodiments.

FIG. 32 is a flowchart of a message merging method according to some embodiments.

FIG. 33 is a flowchart of a message merging method according to some embodiments.

FIG. 34 is a flowchart of a message merging method according to some embodiments.

FIG. 35 is a flowchart of a message merging method according to some embodiments.

FIG. 36 is a flowchart of a message merging method according to some embodiments.

FIG. 37 is a flowchart of a message merging method according to some embodiments.

FIG. 38 is a flowchart of a message merging method according to some embodiments.

FIG. 39 is a flowchart of a message merging method according to some embodiments.

FIG. 40 is a flowchart of a message merging method according to some embodiments.

FIG. 41 is a schematic diagram of a chat interface according to some embodiments.

FIG. 42 is a flowchart of a message merging method according to some embodiments.

FIG. 43 is a flowchart of a message merging method according to some embodiments.

FIG. 44 is a flowchart of a generation algorithm model according to some embodiments.

FIG. 45 is a block diagram of a message merging apparatus according to some embodiments.

FIG. 46 is a block diagram of a message merging apparatus according to some embodiments.

FIG. 47 is a block diagram of a computer device according to some embodiments.

### DESCRIPTION OF EMBODIMENTS

To make objectives, technical solutions, and advantages of this application clearer, implementations of this application are further described below in detail with reference to the accompanying drawings.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

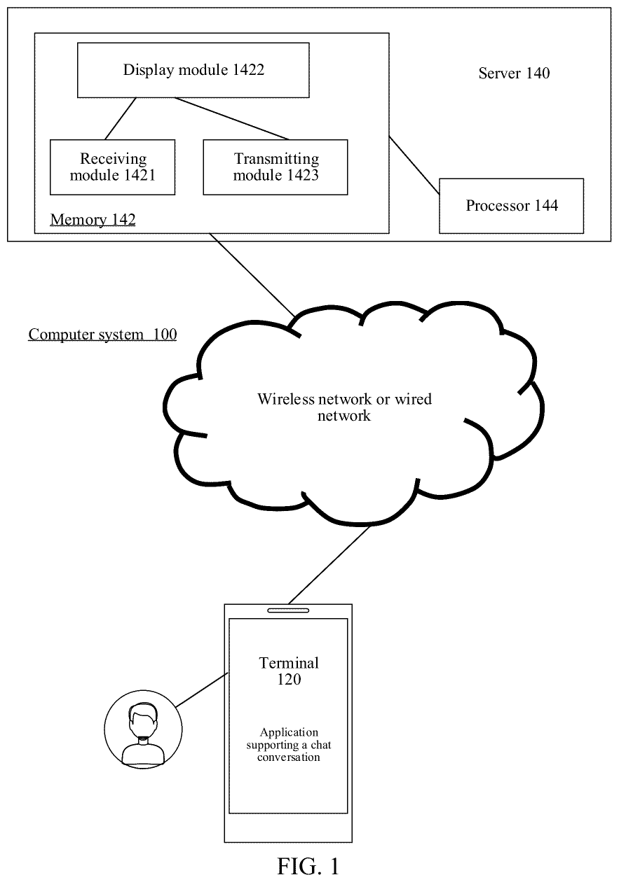

FIG. 1 is a structural block diagram of a computer system 100 according to some embodiments. The computer system 100 includes: a terminal 120 and a server 140.

An application or a web page that supports a chat conversation is installed and run on the terminal 120. The application supporting a chat conversation implements interaction with a user account by using a chat page. The user account implements online chat by transmitting a message of a first media type on the chat page. The message of the first media type includes at least one of a text message, a picture message, a voice message, an emoji message, a voice emoji message, or a video message. In some embodiments, the application supporting a chat conversation is an application capable of providing a chat function. In some embodiments, the application supporting a chat conversation is an application that only provides the chat function. For example, the application supporting a chat conversation is an instant messaging application. In some embodiments, the application supporting a chat conversation is a client that provides at least two functions, and the at least two functions include the chat function. For example, the application supporting a chat conversation is a game program.

The terminal 120 is connected to the server 140 by using a wireless network or a wired network.

The server 140 includes at least one of a server, a plurality of servers, a cloud computing platform, or a virtualization center. For example, the server 140 includes a memory 142 and a processor 144. The memory 142 further includes a receiving module 1421, a display module 1422, and a transmitting module 1423. The receiving module 1421 is configured to receive a request transmitted by the terminal; the display module 1422 is configured to display a program page of the application; and the transmitting module 1423 is configured to transmit a response to the terminal. The server 140 is configured to provide a background service for the application supporting a chat conversation. In some embodiments, the server 140 is responsible for primary computing work and the terminal 120 is responsible for secondary computing work; or the server 140 is responsible for secondary computing work and the terminal 120 is responsible for primary computing work; or the server 140 and the terminal 120 are responsible for computing work in a coordinated manner.

In some embodiments, an AI model configured for merging messages is run in the server. For example, an AI model configured for merging emoji messages. After receiving emoji messages satisfying a merging display condition, the server merges the emoji messages satisfying the merging display condition by using the AI model configured for merging the emoji messages, to obtain one merged message. The server transmits the merged message to the terminal for display.

In some embodiments, device types of the terminal 120 include: at least one of a smartphone, a smartwatch, an in-vehicle terminal, a wearable device, a smart television, a tablet computer, an e-book reader, an MP3 player, an MP4 player, a laptop portable computer, or a desktop computer. An example in which the terminal includes a smartphone is used for description in the following embodiments.

A person skilled in the art may learn that there may be more or fewer terminals. For example, there may be only one terminal, or there may be dozens of or hundreds of terminals or more. A quantity of terminals and the device types of the terminals are not limited in some embodiments.

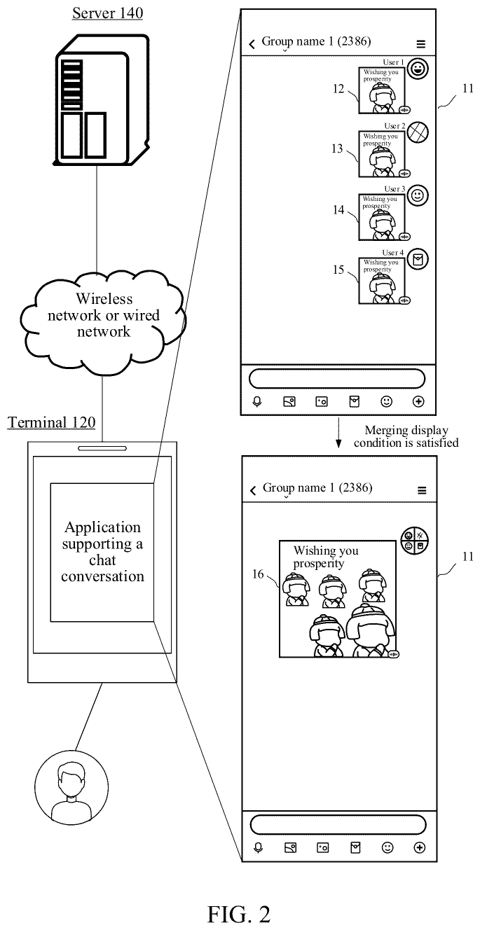

The user account implements online one-to-one communication or one-to-many communication by using the application supporting a chat conversation. For example, as shown in FIG. 2, the application supporting a chat conversation is installed in the terminal 120, and the user accounts perform an online chat conversation by transmitting the message of the first media type on a chat interface 11 of the application supporting a chat conversation.

However, during communication on the chat interface 11, the user accounts may transmit a large quantity of same or similar messages of the first media type. For example, the user accounts transmit a plurality of same emojis for expressing the same emotion. High frequency coverage of these same or similar messages of the first media type on the chat interface 11 causes that the user accounts cannot find useful information on the chat interface 11 as soon as possible. Therefore, these same or similar messages of the first media type may cause interference to some user accounts.

To resolve the foregoing problem, an embodiment of this application provides a message merging method, which can effectively resolve a problem of high frequency coverage of a large quantity of same or similar messages of the first media type on a chat interface, so that a user account that needs to transmit the same or similar messages of the first media type can continue to transmit the messages, and these same or similar messages of the first media type cannot affect another user account.

In some embodiments, the message merging method provided in some embodiments is executed by the terminal. In some embodiments, the message merging method provided in some embodiments is executed by the server. In some embodiments, the message merging method provided in some embodiments is cooperatively executed by the terminal and the server. An example in which the method is executed by the terminal 120 shown in FIG. 1 is used for description.

In some embodiments, the chat interface 11 displays at least one message of the first media type transmitted by at least one user account. For example, the chat interface 11 displays a message 12 of the first media type transmitted by a user account 1, a message 13 of the first media type transmitted by a user account 2, and more messages of the first media type transmitted by more user accounts. In some embodiments, the same user account can transmit a plurality of same messages of the first media type repeatedly. In some embodiments, the same user account can transmit a plurality of different messages of the first media type. In some embodiments, different user accounts can transmit a plurality of same messages of the first media type. In some embodiments, different user accounts can transmit a plurality of different messages of the first media type.

For example, as shown in FIG. 2, four messages of the first media type are displayed on the chat interface 11. Content of the four messages of the first media type is the same, for example, the message 12 of the first media type transmitted by the user account 1, the message 13 of the first media type transmitted by the user account 2, a message 14 of the first media type transmitted by a user account 3, and a message 15 of the first media type transmitted by a user account 4 are the same messages. In a case that a user account 5 transmits a message the same as the message 12 of the first media type, the message 13 of the first media type, the message 14 of the first media type, and the message 15 of the first media type, a merged message 16 is displayed on the chat interface 11. The merged message 16 is obtained by merging the message 12 of the first media type, the message 13 of the first media type, the message 14 of the first media type, the message 15 of the first media type, and the message of the first media type.

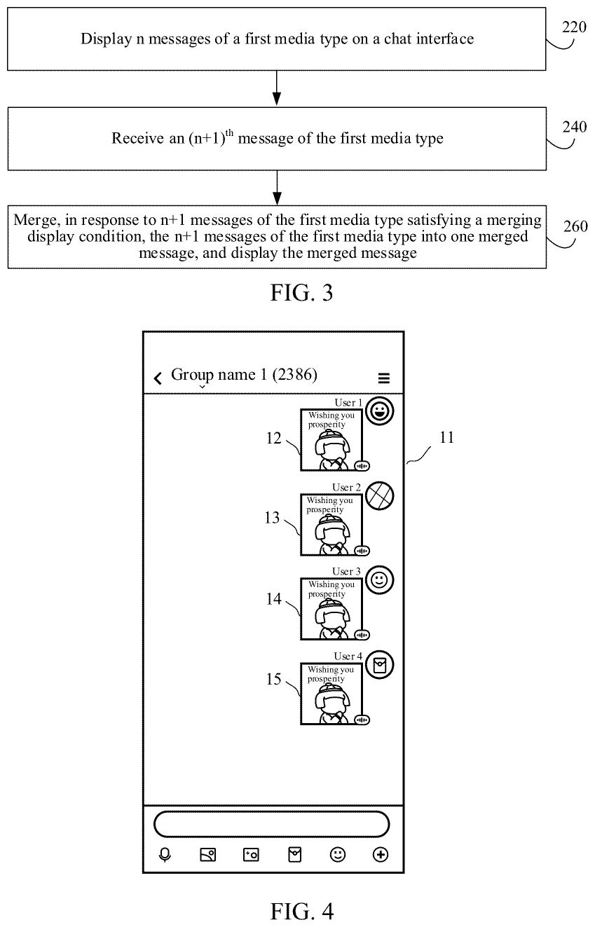

FIG. 3 is a flowchart of a message merging method according to some embodiments. The method is executed by the terminal 120 in the computer system 100 shown in FIG. 1, and includes:

Operation 220: Display n messages of a first media type on a chat interface, N being a positive integer.

The n messages of the first media type are displayed on the chat interface of a client. The client is a client capable of providing a chat function. In some embodiments, the client is a client that only provides the chat function. For example, the client is an instant messaging client. In some embodiments, the client is a client that provides at least two functions, and the at least two functions include the chat function. For example, the client is a game client.

The message of the first media type includes at least one of a text message, a picture message, a voice message, an emoji message, a voice emoji message, or a video message.

In some embodiments, each message of the first media type in the n messages of the first media type corresponds to the same user account. In some embodiments, messages of the first media type in the n messages of the first media type correspond to different user accounts. In some embodiments, some of the n messages of the first media type correspond to the same user account, and some of the messages of the first media type correspond to different user accounts.

For example, as shown in FIG. 4, four messages of the first media type are displayed on a chat interface 11, which are respectively a message 12 of the first media type transmitted by a user account 1, a message 13 of the first media type transmitted by a user account 2, a message 14 of the first media type transmitted by a user account 3, and a message 15 of the first media type transmitted by a user account 4.

Operation 240: Receive an (n+1)^{th} message of the first media type.

In some embodiments, the client may receive the (n+1)^{th} message of the first media type but does not directly display the (n+1)^{th} message of the first media type. In some embodiments, the client may only receive but does not display the (n+1)^{th} message of the first media type. In some embodiments, a user account transmitting the (n+1)^{th} message of the first media type is a user account in at least one user account corresponding to the n messages of the first media type. In some embodiments, the user account transmitting the (n+1)^{th} message of the first media type is not a user account among the at least one user account corresponding to the n messages of the first media type.

In some embodiments, the client may receive and display the (n+1)^{th} message of the first media type.

Operation 260: Merge, in response to n+1 messages of the first media type satisfying a merging display condition, the n+1 messages of the first media type into one merged message, and display the merged message.

In some embodiments, the merging display condition is a trigger condition configured for triggering at least one same item to merge the n+1 messages of the first media type into one merged message and display the merged message.

In some embodiments, the merging display condition is preset. For example, the merging display condition that is preset in advance is: receiving five same messages of the first media type. In a case that the fifth same message of the first media type is received, merging the n+1 messages of the first media type into one merged message is triggered and the merged message is displayed.

In some embodiments, the merging display condition is dynamically adjusted. In some embodiments, the merging display condition is dynamically adjusted based on a display situation of the client. The display situation includes at least one of a display size of the chat interface or a quantity of online users. In some embodiments, the merging display condition is adjusted based on the display size of the chat interface, and the display size of the chat interface is in direct proportion to a quantity of messages of the first media type that are displayed on the chat interface. For example, a larger display size of the chat interface indicates a larger quantity of messages of the first media type that are displayed on the chat interface. A smaller display size of the chat interface indicates a smaller quantity of messages of the first media type that are displayed on the chat interface. For example, in a case that the display size of the chat interface is a display size 1, the merging display condition is a merging display condition 1; and in a case that the display size of the chat interface is a display size 2, the merging display condition is a merging display condition 2. In some embodiments, the merging display condition is adjusted based on the quantity of online users on the chat interface.

In some embodiments, in response to the n+1 messages of the first media type satisfying the merging display condition, the display of the n messages of the first media type is canceled, and the n+1 messages of the first media type are merged into one merged message and the merged message is displayed.

In some embodiments, message content of the merged message is obtained based on merging of the n+1 messages of the first media type. The n+1 messages of the first media type include the n messages of the first media type and the (n+1)^{th} message of the first media type.

In some embodiments, visual content of the merged message is obtained by merging visual content of the n+1 messages of the first media type. For example, the n+1 messages of the first media type correspond to n+1 pieces of visual content, and the visual content of the merged message is a piece of visual content obtained by merging the n+1 pieces of visual content. In some embodiments, the visual content includes at least one of text content, picture content, or decoration content. The visual content refers to various types of content that transfer information or evoke emotions depending on images, graphics, or multimedia elements.

In some embodiments, voice content of the merged message is obtained based on merging of voice content of the n+1 messages of the first media type. For example, the n+1 messages of the first media type correspond to n+1 pieces of voice content, and the voice content of the merged message is a piece of voice content obtained by merging the n+1 pieces of voice content.

In some embodiments, the message content of the merged message includes a common part and a group part.

The common part is obtained by merging at least one same content item in the n+1 messages of the first media type. In other words, deduplication processing may be performed on a plurality of same content items, and only a single content item is retained. For example, it is assumed that the n+1 messages of the first media type include same text content, the common part is obtained by merging the same text content in the n+1 messages of the first media type. As shown in FIG. 2, if the message 12 of the first media type transmitted by the user account 1, the message 13 of the first media type transmitted by the user account 2, the message 14 of the first media type transmitted by the user account 3, and the message 15 of the first media type transmitted by the user account 4 include the same text content “Wishing you prosperity”, the same text content in the message 12 of the first media type transmitted by the user account 1, the message 13 of the first media type transmitted by the user account 2, the message 14 of the first media type transmitted by the user account 3, and the message 15 of the first media type transmitted by the user account 4 are merged, to obtain the common part “Wishing you prosperity”.

In some embodiments, the common part is obtained by merging some of the same content in the n+1 messages of the first media type. In some embodiments, the common part is obtained by merging all the same content in the n+1 messages of the first media type.

The group part is obtained by combining different content items in the n+1 messages of the first media type. In other words, the group part combines different content items between messages, to obtain the combined content. For example, a plurality of different images are combined and spliced into one image. As shown in FIG. 2, if the message 12 of the first media type transmitted by the user account 1 includes an individual emoji avatar, the message 13 of the first media type transmitted by the user account 2 includes an individual emoji avatar, the message 14 of the first media type transmitted by the user account 3 includes an individual emoji avatar, and the message 15 of the first media type transmitted by the user account 4 includes an individual emoji avatar, a plurality of individual emoji avatars are combined, to obtain a group part including the plurality of individual emoji avatars.

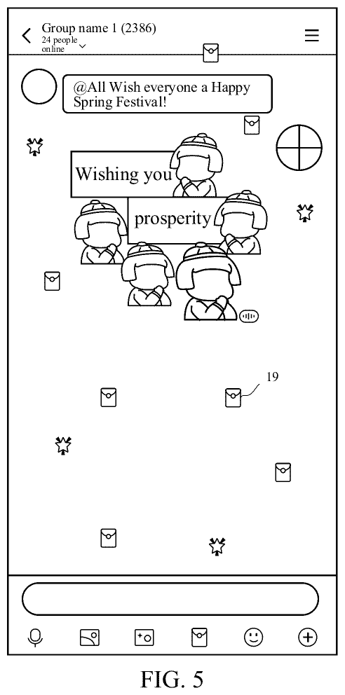

In some embodiments, the message content of the merged message further includes a background atmosphere part. The background atmosphere part is added message content that is used as a background atmosphere in addition to content of the n+1 messages of the first media type. For example, the message content of the background atmosphere may be, for example, a background atmosphere of the group part. In a case that the content of the n+1 messages of the first media type includes the background atmosphere content, the background atmosphere content may be used as the common part or the group part. For example, as shown in FIG. 5, a red packet background 19 is dynamically displayed on the chat interface. The red packet background 19 is background atmosphere content other than content of the n+1 messages of the first media type.

In some embodiments, the message content that is added as the background atmosphere of n+1 pieces of individual content is randomly generated based on a background atmosphere generation model. The background atmosphere generation model is obtained by training a sample training set, and the sample training set includes sample background atmosphere content. A model parameter in the background atmosphere generation model is trained by using the sample training set. After a plurality of times of training, for example, in a case that ten thousand samples are trained or a model converges, a trained background atmosphere generation model that can generate the background atmosphere content is obtained.

In some embodiments, a display attribute in the merged message includes at least one of the following:
a size of a display region of the merged message;
a numeral in the merged message;
a quantity of pieces of individual content in the merged message;
a quantity of decorations in the merged message;
a level of a decoration in the merged message; or
a display manner of the merged message.

In some embodiments, the display attribute in the merged message is related to the quantity of the n+1 messages of the first media type.

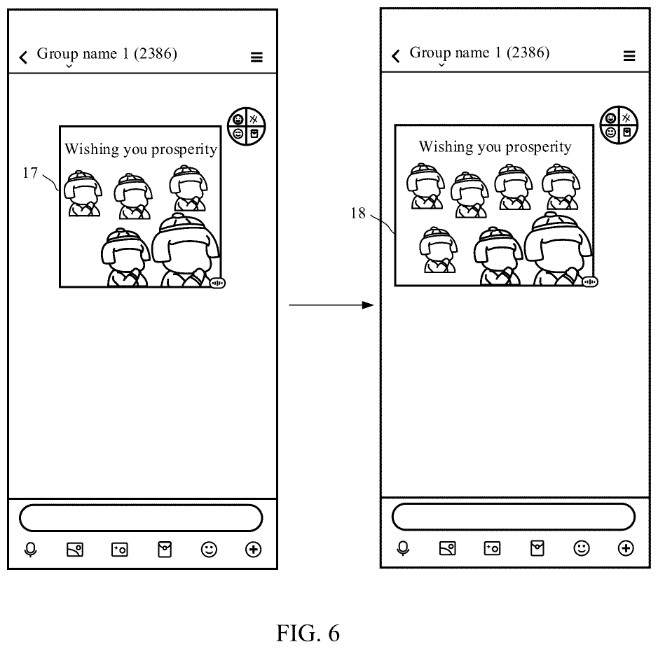

In some embodiments, the size of the display region of the merged message is related to the quantity of the n+1 messages of the first media type. For example, as shown in FIG. 6, the size of the display region of the merged message is in direct proportion to the quantity of the n+1 messages of the first media type, and a larger quantity of the n+1 messages of the first media type indicates a larger size of the display region of the merged message. For example, in a case that the quantity of the n+1 messages of the first media type is 5, the size of the display region of the merged message is 17 dp as a size of a first display region; and in a case that the quantity of the n+1 messages of the first media type is 7, the size of the display region of the merged message is 18 dp as a size of a second display region.

In some embodiments, the numeral in the merged message is related to the quantity of the n+1 messages of the first media type. For example, it is assumed that messages of the first media type satisfying the merging display condition include five messages of the first media type including a mountain, information related to “Five mountains” is displayed in the merged message, and “five” corresponds to “5”. In some embodiments, the numeral in the merged message indicates the quantity of the n+1 messages of the first media type, and the numeral in the merged message is in direct proportion to the quantity of the n+1 messages of the first media type. In some embodiments, the numeral in the merged message is related to the quantity of the n+1 messages of the first media type. In some embodiments, text in the merged message is related to the quantity of the n+1 messages of the first media type. In some embodiments, a text size in the merged message is related to the quantity of the n+1 messages of the first media type. For example, the text size in the merged message is in direct proportion to the quantity of the n+1 messages of the first media type, and a larger quantity of the n+1 messages of the first media type indicates a larger text size in the merged message.

In some embodiments, a quantity of individual content in the merged message is related to the quantity of the n+1 messages of the first media type. For example, the quantity of individual content in the merged message is in direct proportion to the quantity of the n+1 messages of the first media type, and a larger quantity of the n+1 messages of the first media type indicates a larger quantity of individual content in the merged message. For example, as shown in FIG. 6, in a case that each message of the first media type includes one individual emoji avatar, a larger quantity of messages of the first media type indicates a larger quantity of individual content in the merged message. For example, in a case that five messages of the first media type are included, the merged message includes five individual emoji avatars; and in a case that seven messages of the first media type are included, the merged message includes seven individual emoji avatars.

In some embodiments, the quantity of decorations in the merged message is related to the quantity of the n+1 messages of the first media type. For example, the quantity of decorations in the merged message is in direct proportion to the quantity of the n+1 messages of the first media type, and a larger quantity of the n+1 messages of the first media type indicates a larger quantity of decorations in the merged message. For example, as shown in FIG. 5, a larger quantity of messages of the first media type indicates a larger quantity of red packet decorations on the red packet background 19.

In some embodiments, the level of the decoration in the merged message is related to the quantity of the n+1 messages of the first media type. For example, the level of the decoration in the merged message is in direct proportion to the quantity of the n+1 messages of the first media type, and a larger quantity of the n+1 messages of the first media type indicates a higher level of the decoration in the merged message.

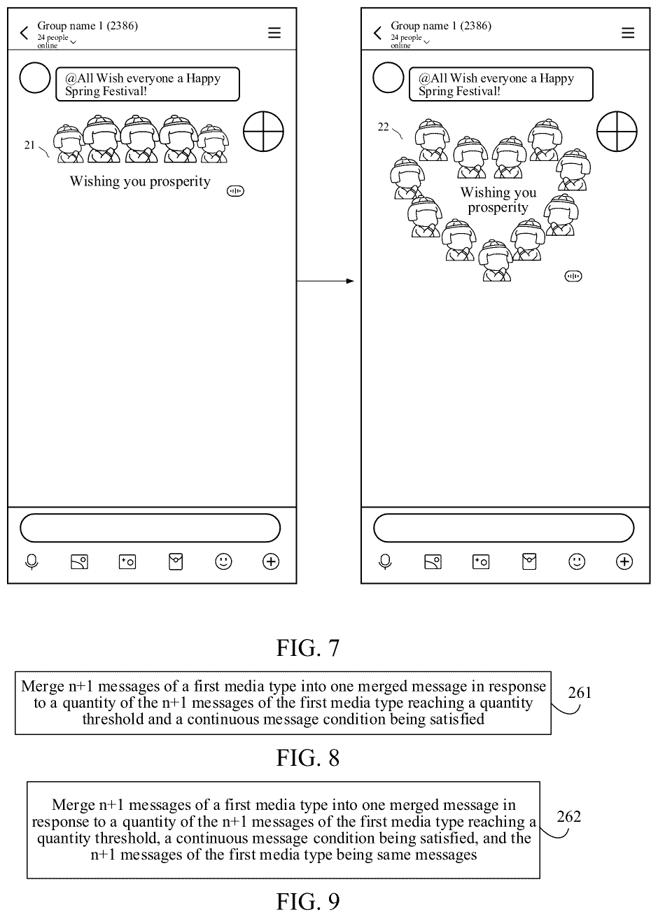

In some embodiments, the display manner of the n+1 pieces of individual content that is configured for representing a group and that is in the merged message is related to the quantity of the n+1 messages of the first media type. For example, as shown in FIG. 7, in a case that the quantity of the n+1 messages of the first media type is five, the display manner of the n+1 pieces of individual content that is configured for representing a group and that is in the merged message is a first display manner 21; and in a case that the quantity of the n+1 messages of the first media type is 11, the display manner of the n+1 pieces of individual content that is configured for representing a group and that is in the merged message is a first display manner 22.

In some embodiments, the merged message is generated by an AI model. The AI model is pre-obtained by training the sample training set, and the sample training set includes a sample message. A model parameter in the AI model is trained by using the sample training set. After a plurality of times of training, for example, in a case that ten thousand samples are trained or a model converges, a trained AI model that can generate the merged message is obtained.

In some embodiments, the AI model includes a synthesis force parameter, the synthesis force parameter includes a synthesis force parameter value, and the synthesis force parameter value indicates a degree of change of the merged message relative to the n+1 messages of the first media type. A larger synthesis force parameter value indicates a larger degree of change of the merged message relative to the n+1 messages of the first media type. For example, a larger synthesis force parameter value indicates that more other elements are added to the merged message.

In some embodiments, the display attribute in the merged message is related to the synthesis force parameter of the AI model.

In conclusion, according to the method provided in some embodiments, in response to the n+1 messages of the first media type satisfying the merging display condition, the n+1 messages of the first media type are merged and displayed as one merged message, so that n messages of the first media type satisfying the merging display condition are displayed on the chat interface at most. In a case that a quantity of messages of the first media type satisfying the merging display condition reaches n+1, only one merged message is displayed on the chat interface. By merging and displaying as one merged message, space utilization of the chat interface is improved, and efficiency of viewing messages by a user can be improved.

In some embodiments, the merging display condition that triggers to merge the n+1 messages of the first media type into one merged message includes: the quantity of the n+1 messages of the first media type reaching a quantity threshold and a continuous message condition being satisfied. As shown in FIG. 8, the foregoing operation 260 may be replaced with the following sub-operation:

Operation 261: Merge n+1 messages of a first media type into one merged message in response to a quantity of the n+1 messages of the first media type reaching a quantity threshold and a continuous message condition being satisfied.

In some embodiments, the quantity threshold is a trigger condition configured for triggering to merge the n+1 messages of the first media type into one merged message.

In some embodiments, the quantity threshold is preset. For example, the quantity threshold preset in advance is: 5 messages of the first media type. In a case that the fifth message of the first media type is received, merging the n+1 messages of the first media type into one merged message is triggered.

In some embodiments, the quantity threshold is dynamically adjusted. In some embodiments, the quantity threshold is dynamically adjusted based on the display size of the chat interface of the client. For example, in a case that the display size of the chat interface is 30 dp*50 dp, the quantity threshold is: 4 messages of the first media type; and in a case that the display size of the chat interface is 50 dp*80 dp, the quantity threshold is: 5 messages of the first media type.

In some embodiments, the continuous message condition refers to that a transmitting time interval between two adjacent messages of the first media type is less than a first threshold, and a quantity of messages of a second media type that are between the two adjacent messages of the first media type is less than a second threshold. The messages of the second media type represent messages of other media type than the first media type in a range of media types supported by the client. For example, the media types supported by the client are various multimedia types. Messages of the first media type are messages of one or more media types, and messages of the second media type are messages of other media types than the first media type in multimedia messages.

In some embodiments, the first threshold is a time threshold indicating the transmitting time interval between the two adjacent messages of the first media type. For example, it is assumed that the two adjacent messages of the first media type are the message 1 of the first media type and the message 2 of the first media type, a transmitting time of the message 1 of the first media type is 10:00, and a transmitting time of the message 2 of the first media type is 10:03. It is assumed that the first threshold is one minute, because a time interval between the transmitting time of the message 1 of the first media type and the transmitting time of the message 2 of the first media type is three minutes, which is greater than the first threshold, the message 1 of the first media type and the message 2 of the first media type do not satisfy the continuous message condition. It is assumed that the first threshold is five minutes, because the time interval between the transmitting time of the message 1 of the first media type and the transmitting time of the message 2 of the first media type is three minutes, which is less than the first threshold, the message 1 of the first media type and the message 2 of the first media type satisfy the continuous message condition.

In some embodiments, the first threshold is preset. In some embodiments, the first threshold is dynamically adjusted.

In some embodiments, the second threshold is a quantity threshold indicating a quantity of messages of the second media type between the two adjacent messages of the first media type. For example, it is assumed that the two adjacent messages of the first media type are the message 1 of the first media type and the message 2 of the first media type, four other messages (for example, messages of the second media type) are included between the message 1 of the first media type and the message 2 of the first media type. It is assumed that the second threshold is five other messages, because a quantity of other messages between the message 1 of the first media type and the message 2 of the first media type is less than the second threshold, the message 1 of the first media type and the message 2 of the first media type satisfy the continuous message condition. It is assumed that the second threshold is three other messages, because the quantity of other messages between the message 1 of the first media type and the message 2 of the first media type is greater than the second threshold, the message 1 of the first media type and the message 2 of the first media type satisfy the continuous message condition.

In some embodiments, the first threshold is preset. In some embodiments, the first threshold is dynamically adjusted.

In conclusion, according to the method provided in some embodiments, in response to the quantity of the n+1 messages of the first media type reaching the quantity threshold and the continuous message condition being satisfied, the n+1 messages of the first media type are merged into one merged message, so that n messages of the first media type satisfying the merging display condition are displayed on the chat interface at most. In a case that a quantity of messages of the first media type satisfying the merging display condition reaches n+1, only one merged message is displayed on the chat interface. By displaying one merged message, space utilization of the chat interface is improved, and efficiency of viewing messages by a user is improved.

In some embodiments, the merging display condition that triggers to merge the n+1 messages of the first media type into one merged message includes: the quantity of the n+1 messages of the first media type reaching the quantity threshold, the continuous message condition being satisfied, and the n+1 messages of the first media type being same messages or messages whose similarities reach a similarity threshold.

In some embodiments, as shown in FIG. 9, the foregoing operation 260 may be replaced with the following sub-operation:

Operation 262: Merge n+1 messages of a first media type into one merged message in response to a quantity of the n+1 messages of the first media type reaching a quantity threshold, a continuous message condition being satisfied, and the n+1 messages of the first media type being same messages.

In some embodiments, the n+1 messages of the first media type are merged and displayed as one merged message in response to the quantity of the n+1 messages of the first media type reaching the quantity threshold, the continuous message condition being satisfied, and the n+1 messages of the first media type being messages of the same subtype. In some embodiments, subtypes of the first media type include an emoji type, a voice type, a voice emoji type, a picture type, and a video type. For example, it is assumed that all the n+1 messages of the first media type are voice emoji messages, for example, all belong to a subtype of the voice emoji type. In response to the quantity of the n+1 messages of the first media type reaching the quantity threshold, the continuous message condition being satisfied, and the n+1 messages of the first media type being voice emoji messages, the n+1 messages of the first media type are merged into one merged message.

In some embodiments, in response to the quantity of the n+1 messages of the first media type reaching the quantity threshold, the continuous message condition being satisfied, and the n+1 messages of the first media type being messages including at least one same content item, the n+1 messages of the first media type are merged into one merged message. In some embodiments, the content item of the message includes at least one of a text content item, a picture content item, or a voice content item. For example, it is assumed that the n+1 messages of the first media type are messages with same text content. In response to the quantity of the n+1 messages of the first media type reaching the quantity threshold, the continuous message condition being satisfied, and the n+1 messages of the first media type being messages with same text content, the n+1 messages of the first media type are merged into one merged message.

In some embodiments, in response to the quantity of the n+1 messages of the first media type reaching the quantity threshold, the continuous message condition being satisfied, and the n+1 messages of the first media type being messages including some same content, the n+1 messages of the first media type are merged into one merged message.

In some embodiments, in response to the quantity of the n+1 messages of the first media type reaching the quantity threshold, the continuous message condition being satisfied, and the n+1 messages of the first media type being messages including all same content, the n+1 messages of the first media type are merged into one merged message.

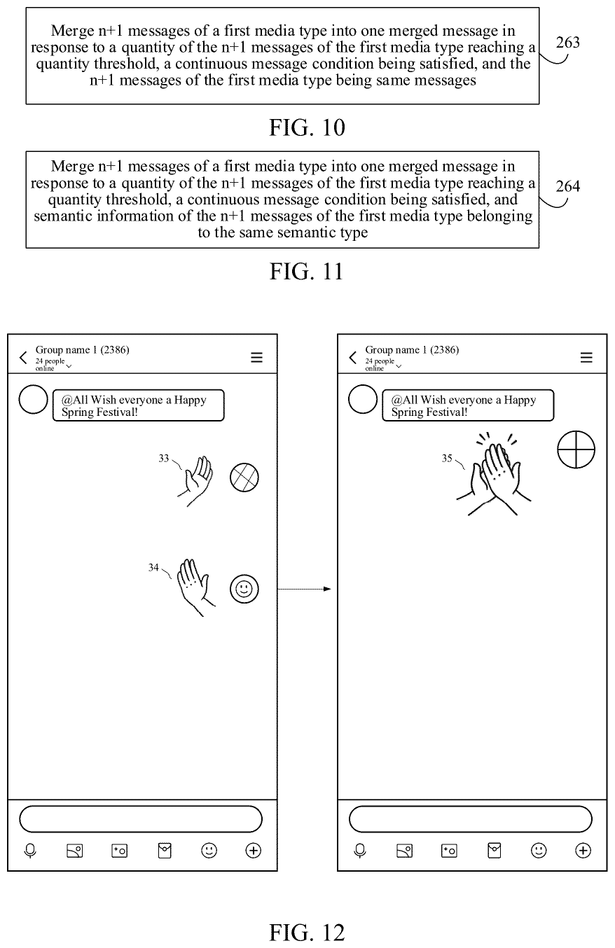

In some embodiments, as shown in FIG. 10, the foregoing operation 260 may be replaced with the following sub-operation:

Operation 263: Merge the n+1 messages of the first media type into one merged message in response to the quantity of the n+1 messages of the first media type reaching the quantity threshold, the continuous message condition being satisfied, and the n+1 messages of the first media type being messages whose similarities reach a similarity threshold. In an embodiment, a similarity between the n+1 messages of the first media type may be represented as a minimum similarity among similarities between any two messages of the n+1 messages of the first media type. For example, similarities between messages in a plurality combinations of the n+1 messages of the first media type may be first calculated, and then a plurality of similarities are sorted to obtain the minimum similarity. Each combination includes two messages of the n+1 messages of the first media type.

In some embodiments, in response to the quantity of the n+1 messages of the first media type reaching the quantity threshold, the continuous message condition being satisfied, and the n+1 messages of the first media type being at least one message whose similarity reaches the similarity threshold, the n+1 messages of the first media type are merged into one merged message. The similarity includes at least one of a picture similarity, a text similarity, or a voice similarity. For example, it is assumed that the n+1 messages of the first media type are voice emoji messages, similarities corresponding to the n+1 messages of the first media type include the picture similarity, the text similarity, and the voice similarity. The similarity threshold is, for example, 0.9.

In some embodiments, in response to the quantity of the n+1 messages of the first media type reaching the quantity threshold, the continuous message condition being satisfied, and the n+1 messages of the first media type being messages whose similarities of some messages reach the similarity threshold, the n+1 messages of the first media type are merged into one merged message.

In some embodiments, in response to the quantity of the n+1 messages of the first media type reaching the quantity threshold, the continuous message condition being satisfied, and the n+1 messages of the first media type being messages whose similarities of all messages reach the similarity threshold, the n+1 messages of the first media type are merged into one merged message.

In some embodiments, the similarity threshold is a threshold indicating a similarity between at least two messages of the first media type.

In some embodiments, the similarity threshold is preset. For example, the similarity threshold preset in advance is: 90%. In a case that a similarity between the n+1 messages of the first media type reaches 90%, the n+1 messages of the first media type are merged and displayed as one merged message. In some embodiments, the similarity threshold is dynamically adjusted.

In some embodiments, the similarity is detected by using a similarity detection model trained in advance. The similarity detection model is obtained by training the sample training set. The sample training set includes at least one of sample text content, sample picture content, sample video content, or sample voice content. A model parameter in the similarity detection model is trained by using the sample training set. After a plurality of times of training, for example, in a case that ten thousand samples are trained or a model converges, a trained similarity detection model that can detect the similarity threshold is obtained.

In conclusion, according to the method provided in some embodiments, in response to the quantity of the n+1 messages of the first media type reaching the quantity threshold, the continuous message condition being satisfied, and the n+1 messages of the first media type being same messages or messages whose similarities reach the similarity threshold, the n+1 messages of the first media type are merged into one merged message, and the n+1 messages of the first media type that satisfy the condition are merged into one merged message, so that the quantity of messages of the first media type that are displayed on the chat interface can be effectively reduced, to avoid confusion of messages displayed on the chat interface, and convenience of displaying messages can be improved, thereby further improving efficiency of viewing messages by a user.

In some embodiments, the merging display condition that triggers to merge the n+1 messages of the first media type into one merged message includes: the quantity of the n+1 messages of the first media type reaching the quantity threshold, the continuous message condition being satisfied, and semantic information of the n+1 messages of the first media type belonging to the same semantic type.

In some embodiments, as shown in FIG. 11, the foregoing operation 260 may be replaced with the following sub-operation:

Operation 264: Merge the n+1 messages of the first media type into one merged message in response to the quantity of the n+1 messages of the first media type reaching the quantity threshold, the continuous message condition being satisfied, and semantic information of the n+1 messages of the first media type belonging to the same semantic type.

In some embodiments, the semantic type includes at least one of the following:
a semantic type representing friend interaction;
a semantic type representing lover interaction;
a semantic type representing communication in a group entertainment activity; or
a semantic type representing communication in a group blessing activity.

In some embodiments, operation 264 may merge the n+1 messages of the first media type into one merged message in response to the quantity of the n+1 messages of the first media type reaching the quantity threshold, the continuous message condition being satisfied, and the n+1 messages of the first media type being complementary-type messages.

In some embodiments, the complementary-type messages include at least one of the following:
messages whose message content is combined with each other as friend interaction;
messages whose message content is combined with each other as lover interaction;
messages whose message content is combined with each other as a group entertainment activity; or
messages whose message content is combined with each other as a group blessing activity.

In some embodiments, in response to the quantity of the n+1 messages of the first media type reaching the quantity threshold, the continuous message condition being satisfied, and the n+1 messages of the first media type being messages whose message content is combined with each other as friend interaction, the n+1 messages of the first media type are merged and displayed as one merged message. For example, it is assumed that two messages of the first media type are included, one message of the first media type is an action message of clapping a left hand, and the other message of the first media type is an action message of clapping a right hand, the two messages of the first media type are merged into one merged message of clapping hands, and the merged message is displayed. For example, as shown in FIG. 12, an action message 33 of clapping a left hand and an action message 34 of clapping a right hand are displayed on the chat interface, and the two messages of the first media type are merged into one merged message 35 of clapping hands.

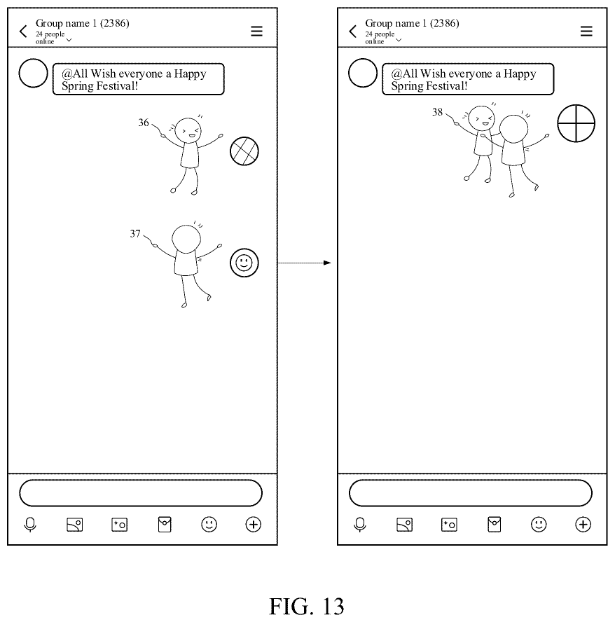

In some embodiments, in response to the quantity of the n+1 messages of the first media type reaching the quantity threshold, the continuous message condition being satisfied, and the n+1 messages of the first media type being messages whose message content is combined with each other as lover interaction, the n+1 messages of the first media type are merged into one merged message. For example, it is assumed that two messages of the first media type are included, one message of the first media type is a hugging action message of a boy, and the other message of the first media type is a hugging action message of a girl, the two messages of the first media type are merged into one merged message indicating hugging. For example, as shown in FIG. 13, a hugging action message 36 of a man and a hugging action message 37 of a girl are displayed on the chat interface, and the two messages of the first media type are merged into one merged message 38 indicating hugging.

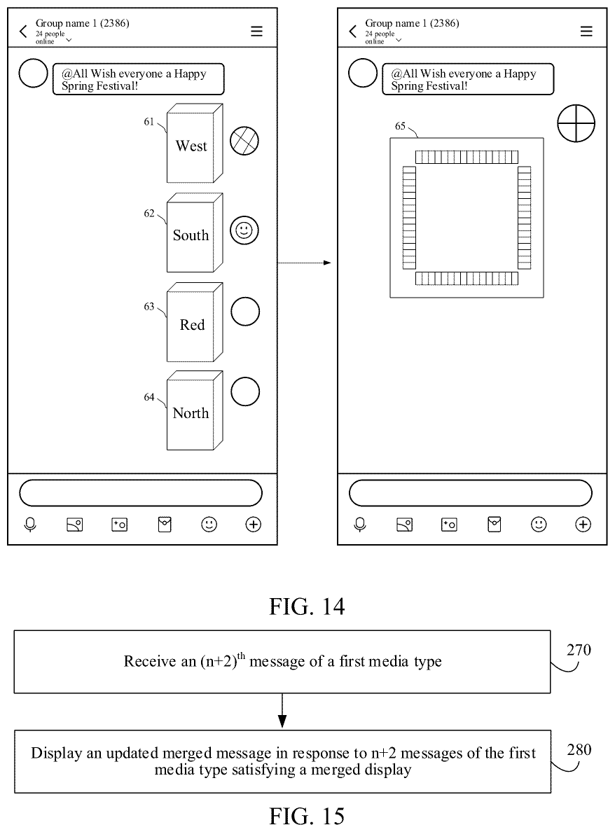

In some embodiments, in response to the quantity of the n+1 messages of the first media type reaching the quantity threshold, the continuous message condition being satisfied, and the n+1 messages of the first media type being messages whose message content is combined with each other as communication in a group entertainment activity, the n+1 messages of the first media type are merged and displayed as one merged message. For example, it is assumed that four messages of the first media type are included, a first message of the first media type is an action message of playing a first mahjong tile, a second message of the first media type is an action message of playing a second mahjong tile, a third message of the first media type is an action message of playing a third mahjong tile, and a fourth message of the first media type is an action message of playing a fourth mahjong tile, the four messages of the first media type are merged into one merged message of playing mahjong tiles on a mahjong table. For example, as shown in FIG. 14, a message 61 of an action of playing a first mahjong tile, a message 62 of an action of playing a second mahjong tile, a message 63 of an action of playing a third mahjong tile, and a message 64 of an action of playing a fourth mahjong tile are displayed on the chat interface, the four messages of the first media type are merged into one merged message 65 indicating playing mahjong tiles on the mahjong table.

In some embodiments, the merged message varies as a quantity of messages whose message content are combined with each other as a group entertainment activity varies. For example, in a case that three chess and card messages are included, a merged message of playing Doudizhu is displayed; in a case that four chess and card messages are included, a merged message of playing mahjong tiles is displayed; and in a case that five chess and card messages are included, a merged message of playing Chinese Poker is displayed.

In some embodiments, in response to the quantity of the n+1 messages of the first media type reaching the quantity threshold satisfying the continuous message condition and the n+1 messages of the first media type being messages whose message content is combined with each other as a group blessing activity, the n+1 messages of the first media type are merged into one merged message. For example, it is assumed that two messages of the first media type are included, one message of the first media type is a voice message 1 “Congratulations” transmitted by the user account 1, and the other message of the first media type is a voice message 2 “Being rich” transmitted by the user account 2, the two messages of the first media type are merged into one voice merged message indicating “Wishing you prosperity”.

In conclusion, according to the method provided in some embodiments, in response to the quantity of the n+1 messages of the first media type reaching the quantity threshold, the continuous message condition being satisfied, and the n+1 messages of the first media type being complementary-type messages, the n+1 messages of the first media type are merged and displayed as one merged message, so that the complementary-type messages on the chat interface can be merged and displayed. A quantity of messages displayed in a chat window is reduced, to avoid interference from a large quantity of messages satisfying the merging display condition. In addition, the complementary-type messages are merged to present a new display manner, thereby enriching interest of messages on the chat interface.

In some embodiments, in a case that an (n+2)^{th} message of a first media type is received, an updated merged message is updated and displayed on a chat interface. As shown in FIG. 15, the foregoing method further includes:

Operation 270: Receive an (n+2)^{th} message of a first media type.

In some embodiments, the client only receives the (n+2)^{th} message of the first media type. In some embodiments, the client receives but does not display the (n+2)^{th} message of the first media type. In some embodiments, a user account transmitting the (n+2)^{th} message of the first media type is a user account among at least one user account corresponding to the n+1 messages of the first media type. In some embodiments, a user account transmitting the (n+2)^{th} message of the first media type is not a user account among the at least one user account corresponding to the n+1 messages of the first media type.

In some embodiments, the client receives and displays the (n+2)^{th} message of the first media type.

Operation 280: Display an updated merged message in response to n+2 messages of the first media type satisfying a merging display condition.

In some embodiments, the n+2 messages of the first media type include the n+1 messages of the first media type and the (n+2)^{th} message of the first media type. In a case that the n+2 messages of the first media type satisfy the merging display condition, the updated merged message is displayed in response to receiving the (n+2)^{th} message of the first media type. Message content of the updated merged message is obtained by merging the n+2 messages of the first media type.

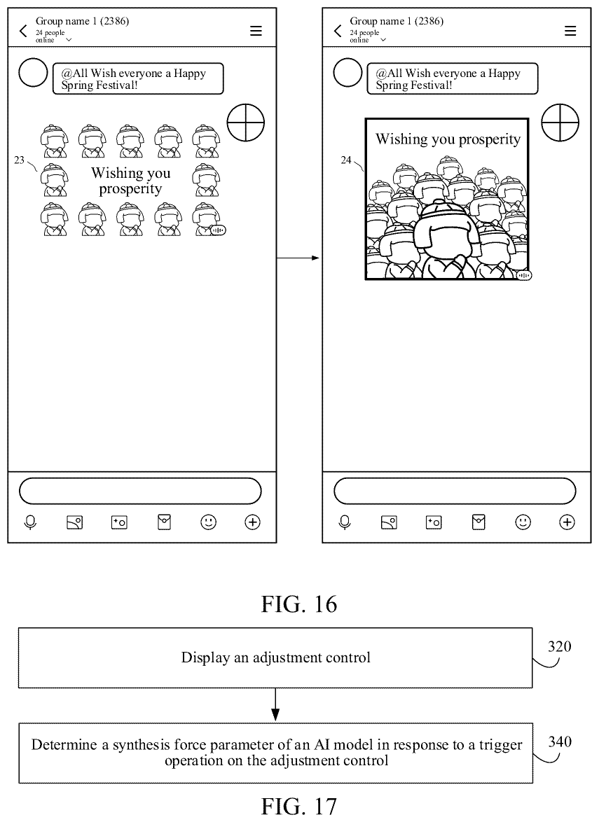

For example, as shown in FIG. 16, a first merged message 23 obtained based on merging of the n+1 messages of the first media type is displayed on the chat interface. In response to receiving the (n+2)^{th} message of the first media type and the n+1 messages of the first media type and the (n+2)^{th} message of the first media type satisfying the merging display condition, an updated merged message 24 is displayed on the chat interface.

In conclusion, according to the method provided in some embodiments, in a case that a new message of the first media type satisfying the merging display condition is continuously received, the updated merged message is displayed, so that one merged message is always displayed on the chat interface, but the merged message is continuously updated based on the received message, and the merged message can be continuously dynamically adjusted and changed, which not only ensures that a display environment on the chat interface is not affected, but also makes the display manner of the messages on the chat interface more diversified. In addition, according to the method in some embodiments, display efficiency of messages can be improved by updating the merged message.

In some embodiments, as shown in FIG. 17, the foregoing method further includes:

Operation 320: Display an adjustment control.

In some embodiments, the adjustment control is configured to adjust a synthesis force parameter of an AI model. The AI model is configured for generating a merged message.

A display form of the adjustment control is not limited in some embodiments. For example, the adjustment control is a rotary knob. In some embodiments, the adjustment control is an adjustment lever. In some embodiments, the adjustment control is an input key.

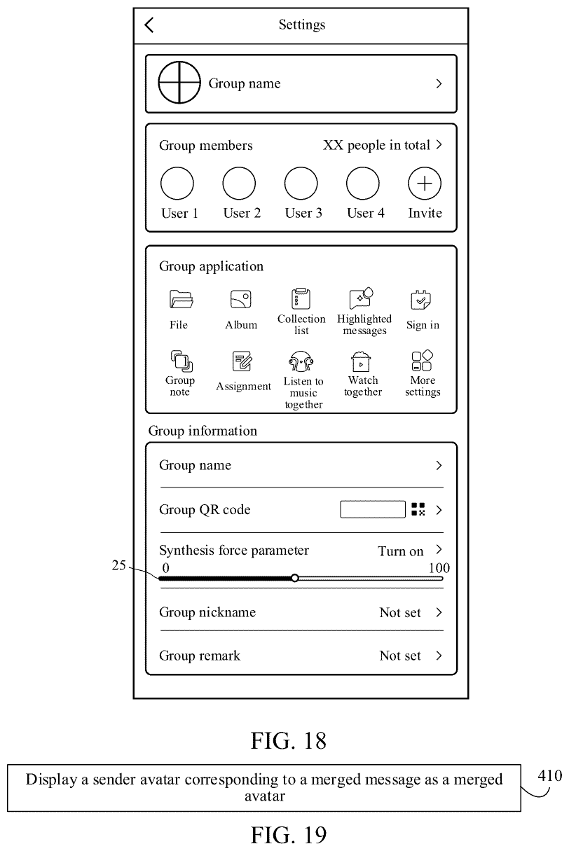

In some embodiments, the adjustment control is displayed on the chat interface. In some embodiments, the adjustment control is displayed on a setting page. In some embodiments, an example in which the adjustment control is displayed on the setting page is used for description. A display location of the adjustment control is not limited. For example, as shown in FIG. 18, an adjustment control 25 is displayed on the setting page.

Operation 340: Determine a synthesis force parameter of an AI model in response to a trigger operation on the adjustment control.

The trigger operation includes at least one of clicking, double clicking, sliding left and right, sliding up and down, long-pressing, hovering, facial recognition, or voice recognition. The trigger operation includes, but is not limited to, the foregoing mentioned several operations. A person skilled in the art is to be learned that any operation that can implement the foregoing functions falls within the protection scope of some embodiments.

In some embodiments, the adjustment control includes an adjustment sub-control for each synthesis force sub-parameter of the synthesis force parameter of the AI model. For example, in a case that the synthesis force parameter of the AI model includes a synthesis force sub-parameter 1 for a sound and a synthesis force sub-parameter 2 for a picture, the adjustment control includes an adjustment sub-control 1 for the synthesis force sub-parameter 1 and an adjustment sub-control 2 for the synthesis force sub-parameter 2.

In conclusion, according to the method provided in some embodiments, the adjustment control is displayed, so that the synthesis force parameter configured for controlling the merged message can be adjusted by using the adjustment control, thereby improving a sense of participation of a user, and the merged message is generated based on a set synthesis force parameter, thereby making the merged message to better meet user requirements.

In some embodiments, as shown in FIG. 19, the foregoing method further includes:

Operation 410: Display a sender avatar corresponding to a merged message as a merged avatar.

In some embodiments, the merged avatar is obtained by merging all avatars or some avatars of sender avatars of the n+1 messages of the first media type.

In some embodiments, the merged avatar includes all avatars of the sender avatars of the n+1 messages of the first media type.

In some embodiments, the merged avatar includes some avatars of the sender avatars of the n+1 messages of the first media type.

In some embodiments, the some avatars are sender avatars of m messages of the first media type in the n+1 messages of the first media type, a value of m being a positive integer less than or equal to n.

In some embodiments, the m messages of the first media type are m messages of the first media type that are located at a predetermined location in a message sequence. For example, sender avatars of four messages of the first media type that are transmitted earliest are combined into a merged avatar. In a case that the m messages of the first media type are the m messages of the first media type that are located at the predetermined location in the message sequence, the merged avatar is fixed or dynamically changed. If the sender avatars of four messages of the first media type that are transmitted earliest are combined into the merged avatar, the merged avatar is fixed; and if sender avatars of four messages of the first media type that are transmitted latest are combined into a merged avatar, the merged avatar is dynamically changed.

In some embodiments, the m messages of the first media type are randomly and dynamically selected. For example, m messages of the first media type are randomly selected from the n+1 messages of the first media type for combination.

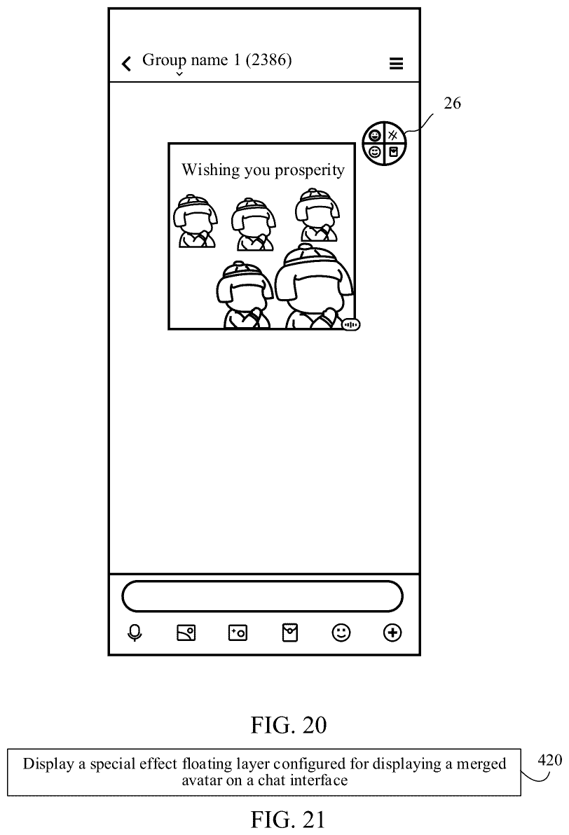

For example, as shown in FIG. 20, a merged avatar 26 is displayed on the chat interface.

In some embodiments, as shown in FIG. 21, the foregoing method further includes:

Operation 420: Display a special effect floating layer configured for displaying the merged avatar on a chat interface.

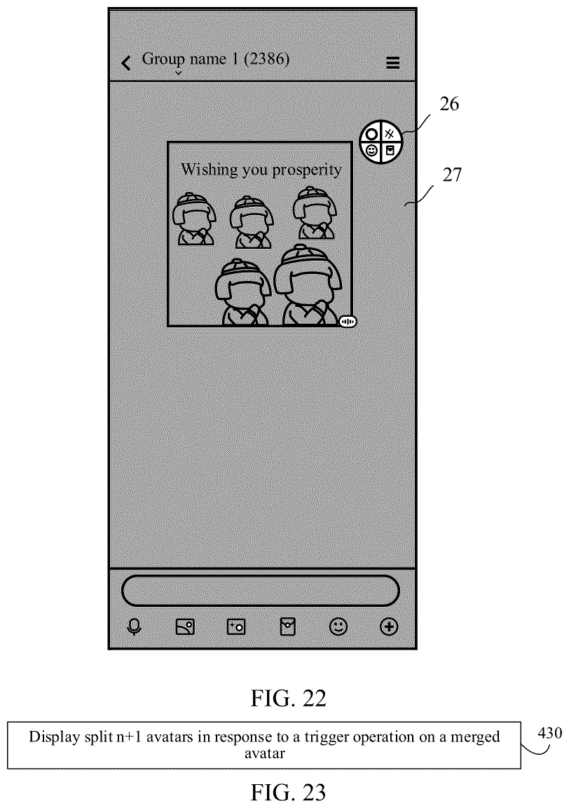

In some embodiments, the special effect floating layer is configured for prompting that the merged message is displayed on the chat interface. For example, as shown in FIG. 22, a special effect floating layer 27 configured for displaying the merged avatar 26 is displayed on the chat interface. A display manner of the special effect floating layer is not limited in some embodiments. A person skilled in the art is to be learned that any display manner that can implement the foregoing prompt function falls within the protection scope of some embodiments.

In some embodiments, the special effect floating layer is displayed in a case that the user account does not read the merged message on the chat interface.

In some embodiments, as shown in FIG. 23, the foregoing method further includes:

Operation 430: Display split n+1 avatars in response to a trigger operation on the merged avatar.

In some embodiments, the n+1 avatars are in a one-to-one correspondence with the sender avatars of the n+1 messages of the first media type.

In some embodiments, the trigger operation on the merged avatar indicates that the merged avatar is split. In some embodiments, the trigger operation on the merged avatar includes at least one of clicking, double clicking, sliding left and right, sliding up and down, long-pressing, hovering, facial recognition, or voice recognition. The trigger operation on the merged avatar includes, but is not limited to, the foregoing mentioned several operations. A person skilled in the art is to be learned that any operation that can implement the foregoing functions falls within the protection scope of some embodiments.

In some embodiments, in a case that at least two messages of the first media type in the n+1 messages of the first media type are transmitted by the same user account, a quantity of the sender avatars of the n+1 messages of the first media type is less than n+1. In other words, in a case that t sender avatars of the n+1 messages of the first media type are included, in response to the trigger operation on the merged avatar, the split t avatars are displayed. A value of t is a positive integer less than or equal to n+1, and a value of n is a positive integer.

A display sequence of the split t avatars is not limited in some embodiments. In some embodiments, the display sequence of the split t avatars is in a sequence of transmitting time of the messages of the first media type respectively corresponding to the t avatars. For example, the split t avatars are sequentially displayed based on the transmitting time from earliest to latest. In some embodiments, the display sequence of the split t avatars is in a sequence of quantities of messages of the first media type respectively corresponding to the t avatars. For example, a quantity of messages of the first media type that correspond to each avatar is obtained. It is assumed that an avatar 1 corresponds to 10 messages of the first media type, and an avatar 2 corresponds to 8 messages of the first media type, the messages are sequentially displayed based on a quantity of messages in descending order or sequentially displayed based on a quantity of messages in ascending order.

In some embodiments, the split t avatars are aggregated and displayed in a split display box. The split t avatars are displayed in the split display box. In some embodiments, all avatars in the split t avatars are displayed in the split display box. In some embodiments, some avatars in the split t avatars are displayed in the split display box.

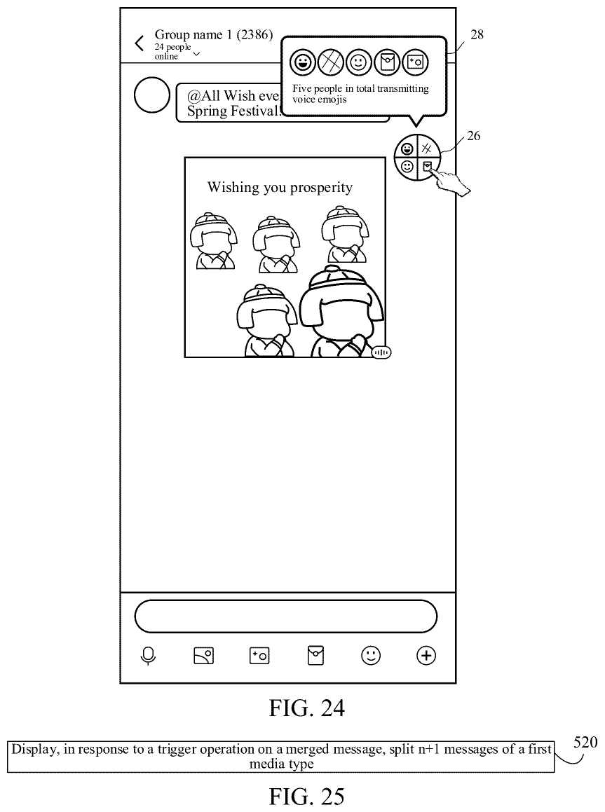

In some embodiments, the split display box is displayed in response to the trigger operation on the merged avatar. For example, as shown in FIG. 24, in response to a click operation on the merged avatar 26, a split display box 28 is displayed, and all split avatars or some split avatars are displayed in the split display box 28.

In some embodiments, in a case that some avatars in the split t avatars are displayed in the split display box, the split display box further includes a viewing control for viewing more avatars. All avatars in the split t avatars are displayed in response to a trigger operation of the viewing control in the split display box.

In some embodiments, the trigger operation of the viewing control includes at least one of clicking, double clicking, sliding left and right, sliding up and down, long-pressing, hovering, facial recognition, or voice recognition. The trigger operation of the viewing control includes, but is not limited to, the foregoing mentioned several operations. A person skilled in the art is to be learned that any operation that can implement the foregoing functions falls within the protection scope of some embodiments.

The foregoing operation 410, operation 420, and operation 430 are separately independent execution operations. The foregoing operation 420 and operation 430 may be executed only when operation 410 is successfully executed. Sequences of the foregoing operation 420 and operation 430 are not distinguished.

In conclusion, according to the method provided in some embodiments, the merged avatar is displayed, so that the user accounts on the chat interface can learn that the merged message is merged based on which user accounts transmitted the messages of the first media type, which can help the user accounts to view and learn from each other to a certain extent.

In some embodiments, as shown in FIG. 25, the foregoing method further includes:

Operation 520: Display, in response to a trigger operation on a merged message, split n+1 messages of a first media type.

In some embodiments, the trigger operation on the merged message indicates that the merged message is split. In some embodiments, the trigger operation on the merged message includes at least one of clicking, double clicking, sliding left and right, sliding up and down, long-pressing, hovering, facial recognition, or voice recognition. The trigger operation on the merged message includes, but is not limited to, the foregoing mentioned several operations. A person skilled in the art is to be learned that any operation that can implement the foregoing functions falls within the protection scope of some embodiments.

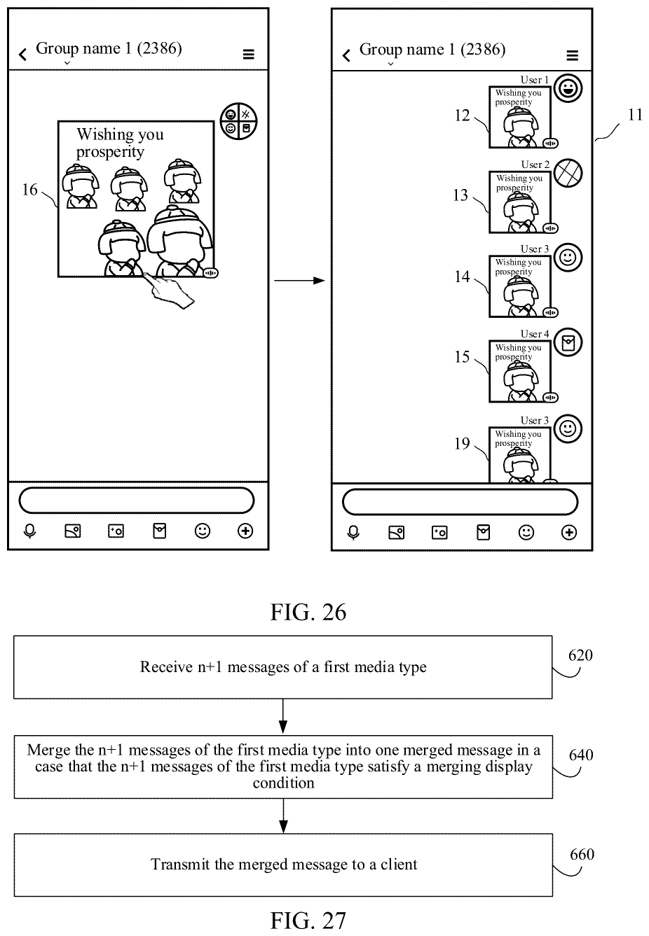

For example, as shown in FIG. 26, in response to a click operation on the merged message 16, a split message 12 of the first media type transmitted by the user account 1, a split message 13 of the first media type transmitted by the user account 2, a split message 14 of the first media type transmitted by the user account 3, a split message 15 of the first media type transmitted by the user account 4, and a split message 19 of the first media type transmitted by the user account 3 are displayed.

In some embodiments, the split n+1 messages of the first media type are displayed based on transmitting time of the n+1 messages of the first media type. In some embodiments, the split n+1 messages of the first media type are sequentially displayed based on transmitting time from earliest to latest. In some embodiments, the split n+1 messages of the first media type are sequentially displayed based on transmitting time from latest to earliest.

A display sequence of the split n+1 messages of the first media type is not limited in some embodiments. In some embodiments, the display sequence of the split n+1 messages of the first media type is in a sequence of transmitting time of the n+1 messages of the first media type. For example, the split n+1 messages of the first media type are sequentially displayed based on the transmitting time from earliest to latest.

In conclusion, according to the method provided in some embodiments, the split n+1 messages of the first media type are displayed, so that the user accounts on the chat interface can view the merged message or a single message based on requirements, thereby providing more selection possibilities for the user accounts.

FIG. 27 is a flowchart of a message merging method according to some embodiments. The method is executed by the server 140 in the computer system 100 shown in FIG. 1, and includes:

Operation 620: Receive n+1 messages of a first media type.

In some embodiments, the server receives the n+1 messages of the first media type. The message of the first media type includes at least one of a text message, a picture message, a voice message, an emoji message, a voice emoji message, or a video message.

In some embodiments, each message of the first media type in the n+1 messages of the first media type corresponds to the same user account. In some embodiments, messages of the first media type in the n+1 messages of the first media type correspond to different user accounts. In some embodiments, some of the n+1 messages of the first media type correspond to the same user account, and some of the n+1 messages of the first media type correspond to different user accounts.

Operation 640: Merge the n+1 messages of the first media type into one merged message in a case that the n+1 messages of the first media type satisfy a merging display condition.

In some embodiments, the merging display condition is a trigger condition configured for triggering to merge the n+1 messages of the first media type into one merged message.

In some embodiments, the merging display condition is preset. For example, the merging display condition that is preset in advance is: receiving five same messages of the first media type. In a case that the fifth same message of the first media type is received, merging the n+1 messages of the first media type into one merged message is triggered.

In some embodiments, the merging display condition is dynamically adjusted. In some embodiments, the merging display condition is dynamically adjusted based on a display situation of a client. The display situation includes at least one of a display size of a chat interface or a quantity of online users. For example, in a case that the display size of the chat interface is a display size 1, the merging display condition is a merging display condition 1; and in a case that the display size of the chat interface is a display size 2, the merging display condition is a merging display condition 2.

In some embodiments, message content of the merged message is obtained based on merging of the n+1 messages of the first media type.

Operation 660: Transmit the merged message to a client.

In some embodiments, the merged message is transmitted to the client for display.

In some embodiments, a display attribute in the merged message includes at least one of the following:
a size of a display region of the merged message;
a numeral in the merged message;
a quantity of pieces of individual content in the merged message;
a quantity of decorations in the merged message;
a level of a decoration in the merged message; or
a display manner of n+1 pieces of individual content that is configured for representing a group and that is in the merged message.

In some embodiments, the display attribute in the merged message is related to a quantity of the n+1 messages of the first media type.

In some embodiments, the size of the display region of the merged message is related to the quantity of the n+1 messages of the first media type. For example, as shown in FIG. 6, the size of the display region of the merged message is in direct proportion to the quantity of the n+1 messages of the first media type, and a larger quantity of the n+1 messages of the first media type indicates a larger size of the display region of the merged message. For example, in a case that the quantity of the n+1 messages of the first media type is 5, the size of the display region of the merged message is 17 as a size of a first display region; and in a case that the quantity of the n+1 messages of the first media type is 7, the size of the display region of the merged message is 18 as a size of a second display region.

In some embodiments, the numeral in the merged message is related to the quantity of the n+1 messages of the first media type. In some embodiments, the numeral in the merged message indicates the quantity of the n+1 messages of the first media type, and the numeral in the merged message is in direct proportion to the quantity of the n+1 messages of the first media type. In some embodiments, the numeral in the merged message is related to the quantity of the n+1 messages of the first media type. In some embodiments, text in the merged message is related to the quantity of the n+1 messages of the first media type. In some embodiments, a text size in the merged message is related to the quantity of the n+1 messages of the first media type. For example, the text size in the merged message is in direct proportion to the quantity of the n+1 messages of the first media type, and a larger quantity of the n+1 messages of the first media type indicates a larger text size in the merged message.

In some embodiments, a quantity of individual content in the merged message is related to the quantity of the n+1 messages of the first media type. For example, the quantity of individual content in the merged message is in direct proportion to the quantity of the n+1 messages of the first media type, and a larger quantity of the n+1 messages of the first media type indicates a larger quantity of individual content in the merged message.

In some embodiments, the quantity of decorations in the merged message is related to the quantity of the n+1 messages of the first media type. For example, the quantity of decorations in the merged message is in direct proportion to the quantity of the n+1 messages of the first media type, and a larger quantity of the n+1 messages of the first media type indicates a larger quantity of decorations in the merged message.

In some embodiments, the level of the decoration in the merged message is related to the quantity of the n+1 messages of the first media type. For example, the level of the decoration in the merged message is in direct proportion to the quantity of the n+1 messages of the first media type, and a larger quantity of the n+1 messages of the first media type indicates a higher level of the decoration in the merged message.

In some embodiments, the display manner of the n+1 pieces of individual content that is configured for representing a group and that is in the merged message is related to the quantity of the n+1 messages of the first media type. For example, as shown in FIG. 7, in a case that the quantity of the n+1 messages of the first media type is five, the display manner of the n+1 pieces of individual content that is configured for representing a group and that is in the merged message is a first display manner 21; and in a case that the quantity of the n+1 messages of the first media type is 11, the display manner of the n+1 pieces of individual content that is configured for representing a group and that is in the merged message is a first display manner 22.

In conclusion, according to the method provided in some embodiments, in a case that the n+1 messages of the first media type satisfy the merging display condition, the n+1 messages of the first media type are merged and displayed as one merged message, so that the client displays the merged message based on the received merged message, thereby effectively avoiding a problem of high frequency coverage of the quantity of same or similar messages of the first media type on the chat interface. A user account that needs to transmit the same or similar messages of the first media type can continue to transmit the large quantity of same or similar messages of the first media type. In addition, these same or similar messages of the first media type can also be merged into one merged message, so as not to affect another user account on the chat interface.

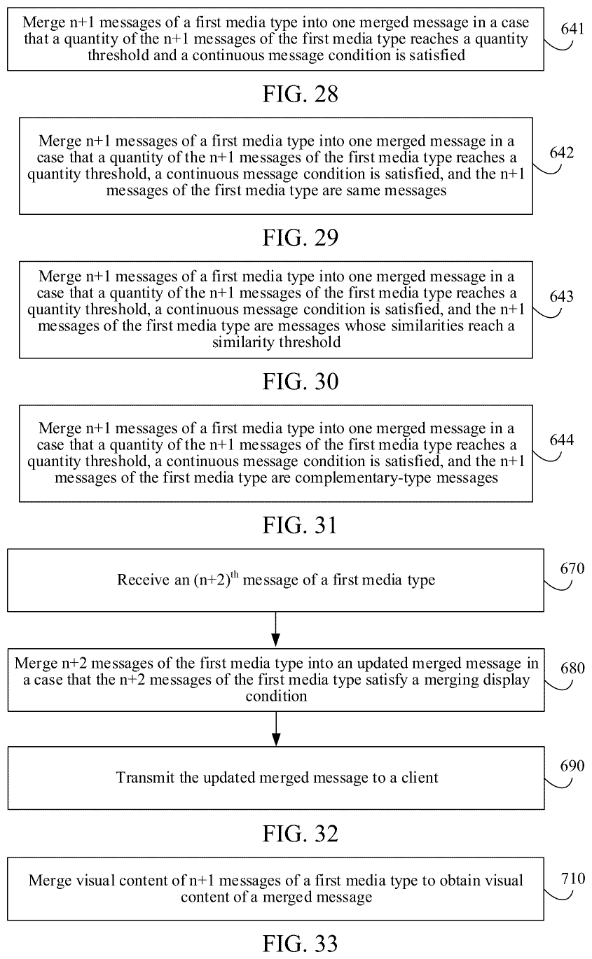

In some embodiments, the merging display condition that triggers to merge the n+1 messages of the first media type into one merged message includes: the quantity of the n+1 messages of the first media type reaching a quantity threshold and a continuous message condition being satisfied. As shown in FIG. 28, the foregoing operation 640 may be replaced with the following sub-operation:

Operation 641: Merge the n+1 messages of the first media type into one merged message in a case that a quantity of the n+1 messages of the first media type reaches a quantity threshold and a continuous message condition is satisfied.

In some embodiments, the quantity threshold is a trigger condition configured for triggering to merge the n+1 messages of the first media type into one merged message.

In some embodiments, the quantity threshold is preset. For example, the quantity threshold preset in advance is: 5 messages of the first media type. In a case that the fifth message of the first media type is received, merging the n+1 messages of the first media type into one merged message is triggered.

In some embodiments, the quantity threshold is dynamically adjusted. In some embodiments, the quantity threshold is dynamically adjusted based on the display size of the chat interface of the client. For example, in a case that the display size of the chat interface is 30 dp*50 dp, the quantity threshold is: 4 messages of the first media type; and in a case that the display size of the chat interface is 50 dp*80 dp, the quantity threshold is: 5 messages of the first media type.

In some embodiments, the continuous message condition refers to that a transmitting time interval between two adjacent messages of the first media type is less than a first threshold, and a quantity of messages of a second media type that are between the two adjacent messages of the first media type is less than a second threshold.

In some embodiments, the first threshold is a time threshold indicating the transmitting time interval between the two adjacent messages of the first media type. For example, it is assumed that the two adjacent messages of the first media type are the message 1 of the first media type and the message 2 of the first media type, a transmitting time of the message 1 of the first media type is 10:00, and a transmitting time of the message 2 of the first media type is 10:03. It is assumed that the first threshold is one minute, because a time interval between the transmitting time of the message 1 of the first media type and the transmitting time of the message 2 of the first media type is three minutes, which is greater than the first threshold, the message 1 of the first media type and the message 2 of the first media type do not satisfy the continuous message condition. It is assumed that the first threshold is five minutes, because the time interval between the transmitting time of the message 1 of the first media type and the transmitting time of the message 2 of the first media type is three minutes, which is less than the first threshold, the message 1 of the first media type and the message 2 of the first media type satisfy the continuous message condition.

In some embodiments, the first threshold is preset. In some embodiments, the first threshold is dynamically adjusted.

In some embodiments, the second threshold is a quantity threshold indicating a quantity of messages of the second media type between the two adjacent messages of the first media type. For example, it is assumed that the two adjacent messages of the first media type are the message 1 of the first media type and the message 2 of the first media type, four other messages are included between the message 1 of the first media type and the message 2 of the first media type. It is assumed that the second threshold is five other messages, because a quantity of other messages between the message 1 of the first media type and the message 2 of the first media type is less than the second threshold, the message 1 of the first media type and the message 2 of the first media type satisfy the continuous message condition. It is assumed that the second threshold is three other messages, because the quantity of other messages between the message 1 of the first media type and the message 2 of the first media type is greater than the second threshold, the message 1 of the first media type and the message 2 of the first media type satisfy the continuous message condition.

In some embodiments, the first threshold is preset. In some embodiments, the first threshold is dynamically adjusted.

In conclusion, according to the method provided in some embodiments, in a case that the quantity of the n+1 messages of the first media type reaches the quantity threshold and the continuous message condition is satisfied, the n+1 messages of the first media type are merged into one merged message, so that the n+1 messages of the first media type that reach the quantity threshold and satisfy the continuous message condition can be merged into one merged message, thereby effectively reducing the quantity of messages of the first media type that are displayed on the chat interface, and avoiding confusion of messages displayed on the chat interface.

In some embodiments, the merging display condition that triggers to merge the n+1 messages of the first media type into one merged message includes: the quantity of the n+1 messages of the first media type reaching the quantity threshold, the continuous message condition being satisfied, and the n+1 messages of the first media type being same messages or messages whose similarities reach a similarity threshold.

In some embodiments, as shown in FIG. 29, the foregoing operation 640 may be replaced with the following sub-operation:

Operation 642: Merge the n+1 messages of the first media type into one merged message in a case that the quantity of the n+1 messages of the first media type reaches the quantity threshold, the continuous message condition is satisfied, and the n+1 messages of the first media type are same messages.

In some embodiments, in a case that the quantity of the n+1 messages of the first media type reaches the quantity threshold, the continuous message condition is satisfied, and the n+1 messages of the first media type are messages of the same subtype, the n+1 messages of the first media type are merged into one merged message. In some embodiments, the subtype is a type obtained by further subdividing the first media type. For example, the subtype includes at least one of an emoji type, a voice type, a voice emoji type, a picture type, or a video type. For example, in a case that the quantity of the n+1 messages of the first media type reaches the quantity threshold, the continuous message condition is satisfied, and the n+1 messages of the first media type are voice emoji messages, the n+1 messages of the first media type are merged into one merged message.

In some embodiments, in a case that the quantity of the n+1 messages of the first media type reaches the quantity threshold, the continuous message condition is satisfied, and the n+1 messages of the first media type are messages including at least one same content item, the n+1 messages of the first media type are merged into one merged message. In some embodiments, the content item of the message includes at least one of a text content item, a picture content item, or a voice content item. For example, in a case that the quantity of the n+1 messages of the first media type reaches the quantity threshold, the continuous message condition is satisfied, and the n+1 messages of the first media type are messages with same text content, the n+1 messages of the first media type are merged into one merged message.

In some embodiments, in a case that the quantity of the n+1 messages of the first media type reaches the quantity threshold, the continuous message condition is satisfied, and the n+1 messages of the first media type are messages including some same content, the n+1 messages of the first media type are merged into one merged message.

In some embodiments, in a case that the quantity of the n+1 messages of the first media type reaches the quantity threshold, the continuous message condition is satisfied, and the n+1 messages of the first media type are messages including all same content, the n+1 messages of the first media type are merged into one merged message.

In some embodiments, as shown in FIG. 30, the foregoing operation 640 may be replaced with the following sub-operation:

Operation 643: Merge the n+1 messages of the first media type into one merged message in a case that the quantity of the n+1 messages of the first media type reaches the quantity threshold, the continuous message condition is satisfied, and the n+1 messages of the first media type are messages whose similarities reach the similarity threshold.

In some embodiments, in a case that the quantity of the n+1 messages of the first media type reaches the quantity threshold, the continuous message condition is satisfied, and the n+1 messages of the first media type are at least one message whose similarity reaches the similarity threshold, the n+1 messages of the first media type are merged into one merged message. The similarity includes at least one of a picture similarity, a text similarity, or a voice similarity. For example, it is assumed that the n+1 messages of the first media type are voice emoji messages, similarities corresponding to the n+1 messages of the first media type include the picture similarity, the text similarity, and the voice similarity.

In some embodiments, in a case that the quantity of the n+1 messages of the first media type reaches the quantity threshold, the continuous message condition is satisfied, and the n+1 messages of the first media type are messages whose partial similarity reaches the similarity threshold, the n+1 messages of the first media type are merged into one merged message.

In some embodiments, in a case that the quantity of the n+1 messages of the first media type reaches the quantity threshold, the continuous message condition is satisfied, and the n+1 messages of the first media type are messages whose similarities all reach the similarity threshold, the n+1 messages of the first media type are merged into one merged message.

In some embodiments, the similarity threshold is a threshold indicating a similarity between at least two messages of the first media type.

In some embodiments, the similarity threshold is preset. For example, the similarity threshold preset in advance is: 90%. In a case that a similarity between the n+1 messages of the first media type reaches 90%, the n+1 messages of the first media type are merged into one merged message. In some embodiments, the similarity threshold is dynamically adjusted.

In some embodiments, the similarity is detected by using a similarity detection model trained in advance. The similarity detection model is obtained by training the sample training set. The sample training set includes at least one of sample text content, sample picture content, sample video content, or sample voice content. A model parameter in the similarity detection model is trained by using the sample training set. After a plurality of times of training, for example, in a case that ten thousand samples are trained or a model converges, a trained similarity detection model that can detect the similarity threshold is obtained.

In conclusion, according to the method provided in some embodiments, in a case that the quantity of the n+1 messages of the first media type reaches the quantity threshold, the continuous message condition is satisfied, and the n+1 messages of the first media type are same messages or messages whose similarities reach the similarity threshold, the n+1 messages of the first media type are merged into one merged message, thereby effectively reducing the quantity of messages of the first media type that are displayed on the chat interface, and avoiding confusion of messages displayed on the chat interface.

In some embodiments, the merging display condition that triggers to merge and display the n+1 messages of the first media type as one merged message includes: the quantity of the n+1 messages of the first media type reaching the quantity threshold, the continuous message condition being satisfied, and the n+1 messages of the first media type being complementary-type messages.

In some embodiments, as shown in FIG. 31, the foregoing operation 640 may be replaced with the following sub-operation:

Operation 644: Merge the n+1 messages of the first media type into one merged message in a case that the quantity of the n+1 messages of the first media type reaches the quantity threshold, the continuous message condition is satisfied, and the n+1 messages of the first media type are complementary-type messages.

In some embodiments, the complementary-type messages include at least one of the following:
messages of a first media type whose message content is combined with each other as friend interaction;
messages of a first media type whose message content is combined with each other as lover interaction;
messages of a first media type whose message content is combined with each other as a group entertainment activity; or
messages of a first media type whose message content is combined with each other as a group blessing activity.

In some embodiments, in a case that the quantity of the n+1 messages of the first media type reaches the quantity threshold, the continuous message condition is satisfied, and the n+1 messages of the first media type are messages whose message content is combined with each other as friend interaction, the n+1 messages of the first media type are merged into one merged message. For example, it is assumed that two messages of the first media type are included, one message of the first media type is an action message of clapping a left hand, and the other message of the first media type is an action message of clapping a right hand, the two messages of the first media type are merged into one merged message of clapping hands.

In some embodiments, in a case that the quantity of the n+1 messages of the first media type reaches the quantity threshold, the continuous message condition is satisfied, and the n+1 messages of the first media type are messages whose message content is combined with each other as lover interaction, the n+1 messages of the first media type are merged into one merged message. For example, it is assumed that two messages of the first media type are included, one message of the first media type is a hugging action message of a boy, and the other message of the first media type is a hugging action message of a girl, the two messages of the first media type are merged into one merged message of hugging.

In some embodiments, in a case that the quantity of the n+1 messages of the first media type reaches the quantity threshold, the continuous message condition is satisfied, and the n+1 messages of the first media type are messages whose message content is combined with each other as a group entertainment activity, the n+1 messages of the first media type are merged into one merged message. For example, it is assumed that four messages of the first media type are included, a first message of the first media type is an action message of playing a first mahjong tile, a second message of the first media type is an action message of playing a second mahjong tile, a third message of the first media type is an action message of playing a third mahjong tile, and a fourth message of the first media type is an action message of playing a fourth mahjong tile, the four messages of the first media type are merged into one merged message of playing mahjong tiles on a mahjong table.

In some embodiments, in a case that the quantity of the n+1 messages of the first media type reaches the quantity threshold, the continuous message condition is satisfied, and the n+1 messages of the first media type are messages whose message content is combined with each other as a group blessing activity, the n+1 messages of the first media type are merged into one merged message. For example, it is assumed that two messages of the first media type are included, one message of the first media type is a voice message 1 “Congratulations” transmitted by the user account 1, and the other message of the first media type is a voice message 2 “Being rich” transmitted by the user account 2, the two messages of the first media type are merged into one voice merged message “Wishing you prosperity”.

In conclusion, according to the method provided in some embodiments, in a case that the quantity of the n+1 messages of the first media type reaches the quantity threshold, the continuous message condition is satisfied, and the n+1 messages of the first media type are complementary-type messages, the n+1 messages of the first media type are merged and displayed as one merged message, so that the complementary-type messages on the chat interface can be merged and displayed. A quantity of messages displayed in a chat window is reduced, to avoid interference from a large quantity of messages satisfying the merging display condition. In addition, the complementary-type messages are merged to present a new display manner, thereby enriching interest of messages on the chat interface.

In some embodiments, in a case that the (n+2)^{th} message of the first media type is received, the merged message is updated. As shown in FIG. 32, the foregoing method further includes:

Operation 670: Receive an (n+2)^{th} message of a first media type.

In some embodiments, a user account transmitting the (n+2)^{th} message of the first media type is a user account among at least one user account corresponding to the n+1 messages of the first media type. In some embodiments, a user account transmitting the (n+2)^{th} message of the first media type is not a user account among the at least one user account corresponding to the n+1 messages of the first media type.

Operation 680: Merge n+2 messages of the first media type into an updated merged message in a case that the n+2 messages of the first media type satisfy a merging display condition.

In some embodiments, the n+2 messages of the first media type include the n+1 messages of the first media type and the (n+2)^{th} message of the first media type. Message content of the updated merged message is obtained based on merging of the n+2 messages of the first media type.

Operation 690: Transmit the updated merged message to the client.

In some embodiments, the updated merged message obtained based on merging of the n+2 messages of the first media type is transmitted to the client for display.

In conclusion, according to the method provided in some embodiments, in a case that a new message of the first media type satisfying the merging display condition is continuously received, the merged message is updated, so that one merged message is always displayed on the chat interface, but the merged message is continuously updated based on the received message, and the merged message can be continuously dynamically adjusted and changed, which not only ensures that a display environment on the chat interface is not affected, but also makes the display manner of the messages on the chat interface more diversified.

In some embodiments, content of a message of the first media type includes visual content. As shown in FIG. 33, the foregoing operation of merging the n+1 messages of the first media type into one merged message may be replaced with the following operation:

Operation 710: Merge visual content of n+1 messages of a first media type to obtain visual content of a merged message.

In some embodiments, the visual content of the merged message is obtained based on merging of the visual content of the n+1 messages of the first media type. For example, the n+1 messages of the first media type correspond to n+1 pieces of visual content, and the visual content of the merged message is a piece of visual content obtained by merging the n+1 pieces of visual content. In some embodiments, the visual content includes at least one of text content, picture content, or decoration content.

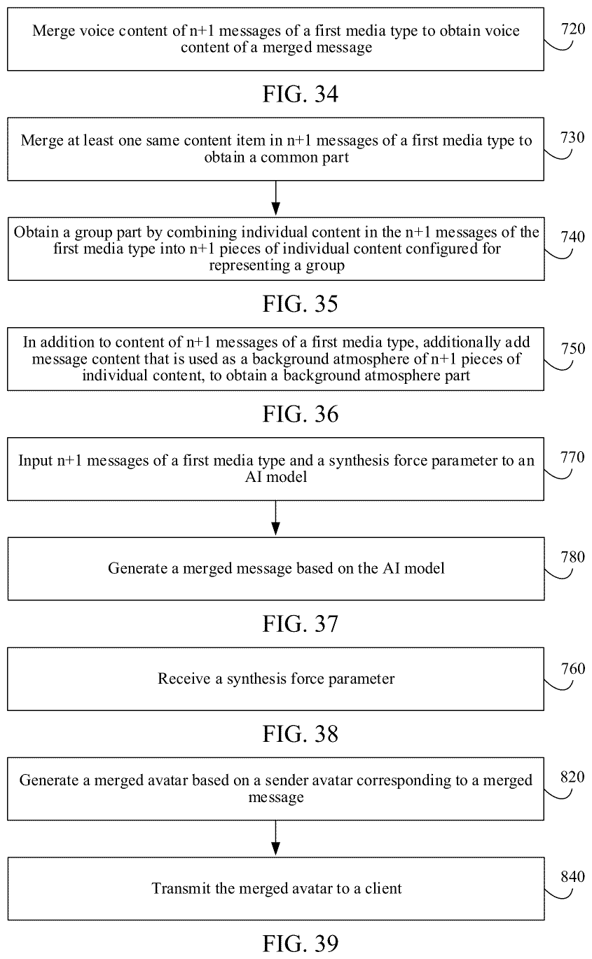

In some embodiments, content of a message of the first media type includes voice content. As shown in FIG. 34, the foregoing operation of merging the n+1 messages of the first media type into one merged message may be replaced with the following operation:

Operation 720: Merge voice content of the n+1 messages of the first media type to obtain voice content of a merged message.

In some embodiments, voice content of the merged message is obtained based on merging of the voice content of the n+1 messages of the first media type. For example, the n+1 messages of the first media type correspond to n+1 pieces of voice content, and the voice content of the merged message is a piece of voice content obtained by merging the n+1 pieces of voice content.

In some embodiments, the message content of the merged message includes a common part and a group part. As shown in FIG. 35, the foregoing operation of merging the n+1 messages of the first media type into one merged message may be replaced with the following operation:

Operation 730: Merge at least one same content item in the n+1 messages of the first media type to obtain a common part.

In some embodiments, the common part is obtained by merging the at least one same content item in the n+1 messages of the first media type. For example, it is assumed that the n+1 messages of the first media type include same text content, the common part is obtained by merging the same text content in the n+1 messages of the first media type. As shown in FIG. 2, if the message 12 of the first media type transmitted by the user account 1, the message 13 of the first media type transmitted by the user account 2, the message 14 of the first media type transmitted by the user account 3, and the message 15 of the first media type transmitted by the user account 4 include the same text content “Wishing you prosperity”, the same text content in the message 12 of the first media type transmitted by the user account 1, the message 13 of the first media type transmitted by the user account 2, the message 14 of the first media type transmitted by the user account 3, and the message 15 of the first media type transmitted by the user account 4 are merged, to obtain the common part “Wishing you prosperity”.

In some embodiments, the common part is obtained by merging some of the same content in the n+1 messages of the first media type. In some embodiments, the common part is obtained by merging all the same content in the n+1 messages of the first media type.

Operation 740: Obtain a group part by combining individual content in the n+1 messages of the first media type into n+1 pieces of individual content configured for representing a group.

In some embodiments, the n+1 messages of the first media type correspond to the n+1 pieces of individual content. Content of the group is content obtained by combining the n+1 pieces of individual content corresponding to the n+1 messages of the first media type.

In some embodiments, the message content of the merged message further includes a background atmosphere part. As shown in FIG. 36, the foregoing operation of merging the n+1 messages of the first media type into one merged message may be replaced with the following operation:

Operation 750: In addition to content of the n+1 messages of the first media type, additionally add message content that is used as a background atmosphere of the n+1 pieces of individual content, to obtain a background atmosphere part.

In a case that the content of the n+1 messages of the first media type includes the background atmosphere content, the background atmosphere content may be used as the common part or the group part.

In some embodiments, the additionally added message content that is used as the background atmosphere of the n+1 pieces of individual content is randomly generated based on a background atmosphere generation model. The background atmosphere generation model is obtained by training a sample training set, and the sample training set includes sample background atmosphere content. A model parameter in the background atmosphere generation model is trained by using the sample training set. After a plurality of times of training, for example, in a case that ten thousand samples are trained or a model converges, a trained background atmosphere generation model that can generate the background atmosphere content is obtained.

In some embodiments, the display attribute in the merged message is related to the synthesis force parameter of the AI model. As shown in FIG. 37, the foregoing operation of merging the n+1 messages of the first media type into one merged message may be replaced with the following operation:

Operation 770: Input n+1 messages of a first media type and a synthesis force parameter to an AI model.

In some embodiments, the AI model is pre-obtained by training a sample training set, and the sample training set includes a sample message. A model parameter in the AI model is trained by using the sample training set. After a plurality of times of training, for example, in a case that ten thousand samples are trained or a model converges, a trained AI model that can generate the merged message is obtained.

In some embodiments, the AI model includes a synthesis force parameter, the synthesis force parameter includes a synthesis force parameter value, and the synthesis force parameter value indicates a degree of change of the merged message relative to the n+1 messages of the first media type. A larger synthesis force parameter value indicates a larger degree of change of the merged message relative to the n+1 messages of the first media type. For example, a larger synthesis force parameter value indicates that more other elements are added to the merged message.

Operation 780: Generate the merged message based on the AI model.

In some embodiments, the AI model generates the merged message based on the inputted n+1 messages of the first media type and the synthesis force parameter.

In some embodiments, the synthesis force parameter includes at least two synthesis force sub-parameters. The AI model generates the merged message based on the inputted n+1 messages of the first media type and the at least two synthesis force sub-parameters. For example, in a case that the synthesis force parameter includes a synthesis force sub-parameter 1 for a sound and a synthesis force sub-parameter 2 for a picture, the AI model generates the merged message based on the inputted n+1 messages of the first media type, the synthesis force sub-parameter 1 for a sound, and the synthesis force sub-parameter 2 for a picture.

In some embodiments, as shown in FIG. 38, before operation 770, the method further includes:

Operation 760: Receive the synthesis force parameter.

In some embodiments, the client transmits the synthesis force parameter to the server. The synthesis force parameter is adjusted by using an adjustment control in the client. A synthesis force parameter value of the AI model is determined in response to a trigger operation on the adjustment control. The trigger operation includes at least one of clicking, double clicking, sliding left and right, sliding up and down, long-pressing, hovering, facial recognition, or voice recognition. The trigger operation includes, but is not limited to, the foregoing mentioned several operations. A person skilled in the art is to be learned that any operation that can implement the foregoing functions falls within the protection scope of some embodiments.

In some embodiments, the adjustment control is displayed on the chat interface. In some embodiments, the adjustment control is displayed on a setting page. In some embodiments, an example in which the adjustment control is displayed on the setting page is used for description. A display location of the adjustment control is not limited.

In conclusion, according to the method provided in some embodiments, the merged message that is finally generated based on different conditions may be different. In a case that the user account sets the synthesis force parameter, the merged message is generated based on the synthesis force parameter by using the AI model, so that a sense of participation of the user account can be improved, and the merged message better satisfies a requirement of the user account. The AI model herein is, for example, a model such as a CNN.

In some embodiments, the AI model configured for merging the message of the first media type is obtained through training based on the following method:
obtaining a sample training set configured for training an AI model, the sample training set including a sample message of a first media type and a sample merged message as a label; and
inputting the sample message of the first media type to the AI model, to output a predicted merged message. An error loss between the predicted merged message and the sample merged message is calculated based on a loss function. The model parameter in the AI model is trained based on the error loss by using an error back propagation algorithm. After a plurality of times of training, for example, in a case that ten thousand samples are trained or a model converges, an AI model that can merge the messages of the first media type is obtained.

The loss function configured for calculating the error loss between the predicted merged message and the sample merged message is not limited in some embodiments. A person skilled in the art is to be learned that any loss function that can implement the foregoing calculation falls within the protection scope of some embodiments.

In some embodiments, the sample message of the first media type further corresponds to at least two sample synthesis force parameters. The sample message of the first media type that corresponds to each sample synthesis force parameter is inputted to the AI model, to output the predicted merged message. An error loss between the predicted merged message and the sample merged message is calculated based on a loss function. The model parameter in the AI model is trained based on the error loss by using an error back propagation algorithm.

For example, it is assumed that a sample message 1 of the first media type corresponds to a sample synthesis force parameter 1 and a sample synthesis force parameter 2. The sample message 1 of the first media type that corresponds to the sample synthesis force parameter 1 is inputted to the AI model, to output a predicted merged message 1. An error loss 1 between the predicted merged message 1 and the sample merged message is calculated based on the loss function. Based on the error loss 1, the model parameter in the AI model is trained by using the error back propagation algorithm. The sample message 1 of the first media type that corresponds to the sample synthesis force parameter 2 is inputted to the AI model, to output a predicted merged message 2. An error loss 2 between the predicted merged message 2 and the sample merged message is calculated based on the loss function. Based on the error loss 2, the model parameter in the AI model is trained by using the error back propagation algorithm.

FIG. 39 is a flowchart of a message merging method according to some embodiments. The method is executed by the server 140 in the computer system 100 shown in FIG. 1, and the foregoing method further includes:

Operation 820: Generate a merged avatar based on a sender avatar corresponding to a merged message.

In some embodiments, the merged avatar is obtained based on combination of all avatars or some avatars in sender avatars of n+1 messages of a first media type.

In some embodiments, the merged avatar includes all avatars of the sender avatars of the n+1 messages of the first media type.

In some embodiments, the merged avatar includes some avatars of the sender avatars of the n+1 messages of the first media type.

In some embodiments, the some avatars are sender avatars of m messages of the first media type in the n+1 messages of the first media type, a value of m being a positive integer less than or equal to n.

In some embodiments, the m messages of the first media type are m messages of the first media type at a predetermined location. For example, sender avatars of four messages of the first media type that are transmitted earliest are merged into a merged avatar. In a case that the m messages of the first media type are m messages of the first media type at the predetermined location, the merged avatar is fixed or dynamically changed. If the sender avatars of four messages of the first media type that are transmitted earliest are combined into the merged avatar, the merged avatar is fixed; and if sender avatars of four messages of the first media type that are transmitted latest are combined into a merged avatar, the merged avatar is dynamically changed.

In some embodiments, the m messages of the first media type are randomly and dynamically selected. For example, the m messages of the first media type are randomly selected from the n+1 messages of the first media type for merging.

Operation 840: Transmit the merged avatar to a client.

In some embodiments, the merged avatar is transmitted to the client.

In conclusion, according to the method provided in some embodiments, the merged avatar is generated and the merged avatar is transmitted to the client, so that the user accounts on the chat interface can learn that the merged message is merged based on which user accounts transmitted the messages of the first media type, which can help the user accounts to view and learn from each other to a certain extent.

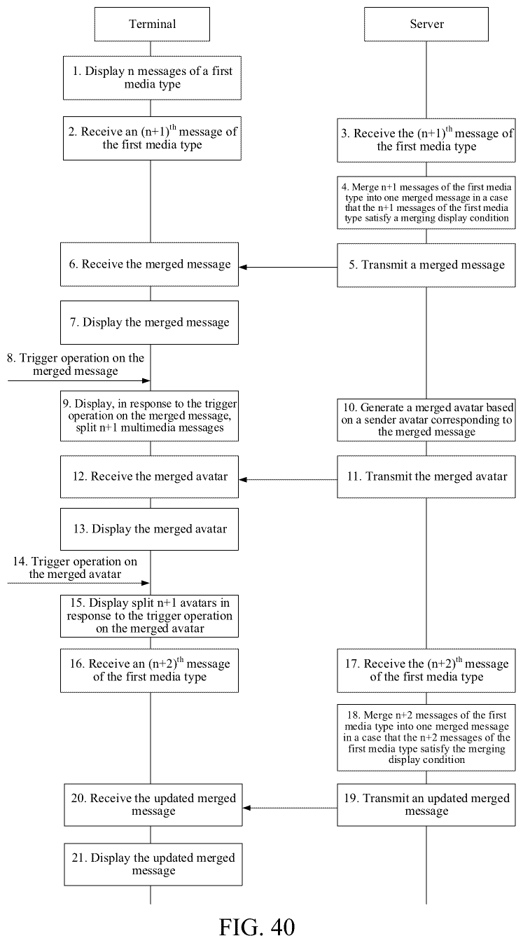

FIG. 40 is a flowchart of a message merging method according to some embodiments. The method is cooperatively executed by the terminal 120 and the server 140 in the computer system 100 shown in FIG. 1, and the foregoing method further includes:

Operation 1: A terminal displays n messages of a first media type.

For a detailed implementation, refer to the foregoing operation 220.

Operation 2: The terminal receives an (n+1)^{th} message of the first media type.

For a detailed implementation, refer to the foregoing operation 240.

Operation 3: A server receives the (n+1)^{th} message of the first media type.

For a detailed implementation, refer to the foregoing operation 620.

Sequences of operation 2 and operation 3 are not distinguished. In some embodiments, operation 2 is executed before operation 3. In some embodiments, operation 3 is executed before operation 2. In some embodiments, operation 2 and operation 3 are simultaneously executed.

Operation 4: The server merges n+1 messages of the first media type into one merged message in a case that the n+1 messages of the first media type satisfy a merging display condition.

For a detailed implementation, refer to the foregoing operation 640.

Operation 5: The server transmits the merged message to the terminal.

For a detailed implementation, refer to the foregoing operation 660.

Operation 6: The terminal receives the merged message transmitted by the server.

The terminal receives the merged message generated by the server in a case that the n+1 messages of the first media type satisfy the merging display condition.

Operation 7: The terminal displays the merged message.

For a detailed implementation, refer to the foregoing operation 260.

Operation 8: The terminal receives a trigger operation of a user account on the merged message.

In some embodiments, the trigger operation on the merged message indicates that the merged message is split. In some embodiments, the trigger operation on the merged message includes at least one of clicking, double clicking, sliding left and right, sliding up and down, long-pressing, hovering, facial recognition, or voice recognition. The trigger operation on the merged message includes, but is not limited to, the foregoing mentioned several operations. A person skilled in the art is to be learned that any operation that can implement the foregoing functions falls within the protection scope of some embodiments.

Operation 9: The terminal displays split n+1 messages of the first media type in response to the trigger operation on the merged message.

For a detailed implementation, refer to the foregoing operation 520.

Operation 10: The server generates a merged avatar based on a sender avatar corresponding to the merged message.

For a detailed implementation, refer to the foregoing operation 820.

Operation 11: The server transmits the merged avatar to the terminal.

For a detailed implementation, refer to the foregoing operation 840.

Operation 12: The terminal receives the merged avatar.

The terminal receives the merged avatar obtained by the server based on all avatars or some avatars of sender avatars of the n+1 messages of the first media type.

Operation 13: The terminal displays the merged avatar.

For a detailed implementation, refer to the foregoing operation 410.

Operation 14: The terminal receives a trigger operation of the user account on the merged avatar.

In some embodiments, the trigger operation on the merged avatar indicates that the merged avatar is split. In some embodiments, the trigger operation on the merged avatar includes at least one of clicking, double clicking, sliding left and right, sliding up and down, long-pressing, hovering, facial recognition, or voice recognition. The trigger operation on the merged avatar includes, but is not limited to, the foregoing mentioned several operations. A person skilled in the art is to be learned that any operation that can implement the foregoing functions falls within the protection scope of some embodiments.

Operation 15: The terminal displays split n+1 avatars in response to a trigger operation on the merged avatar.

For a detailed implementation, refer to the foregoing operation 430.

The foregoing operation 10 to operation 15 may be executed after operation 4.

Operation 16: The terminal receives an (n+2)^{th} message of the first media type.

For a detailed implementation, refer to the foregoing operation 270.

Operation 17: The server receives the (n+2)^{th} message of the first media type.

For a detailed implementation, refer to the foregoing operation 670.

Sequences of operation 16 and operation 17 are not distinguished. In some embodiments, operation 16 is executed before operation 17. In some embodiments, operation 17 is executed before operation 16. In some embodiments, operation 16 and operation 17 are simultaneously executed.

Operation 18: The server merges n+2 messages of the first media type into an updated merged message in a case that the n+2 messages of the first media type satisfy the merging display condition.

For a detailed implementation, refer to the foregoing operation 680.

Operation 19: The server transmits the updated merged message to the terminal.

For a detailed implementation, refer to the foregoing operation 690.

Operation 20: The terminal receives the updated merged message.

The terminal receives the updated merged message generated by the server in a case that the n+2 messages of the first media type satisfy the merging display condition.

Operation 21: The terminal displays the updated merged message.

For a detailed implementation, refer to the foregoing operation 280.

The foregoing operation 16 to operation 21 may be executed after operation 7.

In some embodiments, an example in which a message of a first media type is an emoji message is used for description in the following.

In the related art, emoji messages transmitted in a social software group are independent of each other, each emoji message is displayed in an individual form, and animation and modeling of each emoji message are fixed and unchangeable. Operations such as quoting and adding one of the emoji message can be performed only in addition to the emoji message. Because there are a large quantity of people in the social software group, a phenomenon that a large quantity of homogeneous emoji messages flooded a screen can often be seen. Emoji messages flooded the screen causes a large quantity of invalid emoji messages to appear in the social software group. These repeated emoji messages are only an emotion expression of a user account transmitting an emoji message. For a person receiving the emoji message, message notification brought by a high frequency of emoji messages is only interfered, and the user account can find useful information only by taking a lot of time in the social software group.

To resolve the foregoing problem, an embodiment of this application provides a message merging method, to design a voice emoji function flooded the screen that is more efficient, easy to operate, and more interesting for the user account. The AI model is controlled to generate a new voice emoji message by using a synthesis function of the AI model and a random quantity of people flooded the screen in the social software group. Therefore, expression of personal emotion of the user account can be satisfied when the voice emoji message is transmitted, the voice emoji message can display different forms when the screen is flooded each time, group message interference caused by flooding the screen is avoided, and an important message in the social software group can be received in a shortest time.

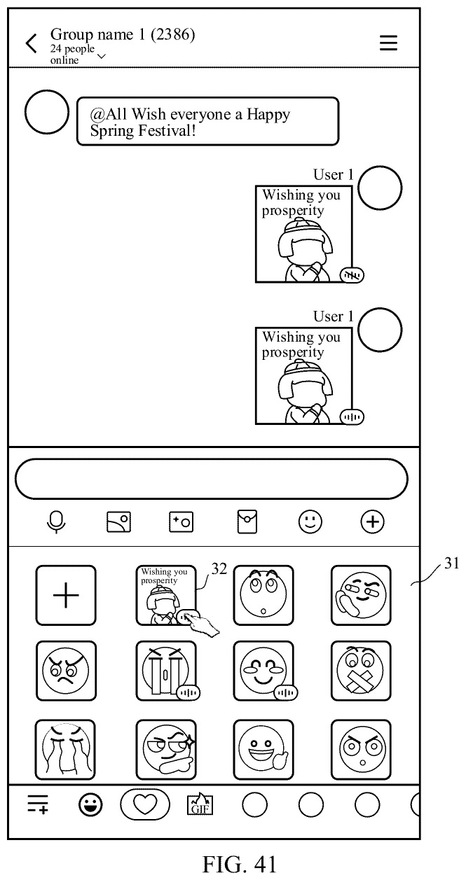

In some embodiments, the user account of the client opens a function panel to select a voice emoji, and transmits the voice emoji message to the chat interface. For example, as shown in FIG. 41, the user account opens a function panel 31, clicks a voice emoji 32 in the function panel 31, and transmits the voice emoji 32 to the chat interface for display.

In some embodiments, the user account may select to open or close a sound of the voice emoji.

In some embodiments, when the same voice emoji message starts to be flooded in the social software group, and a quantity of the voice emoji messages is greater than or equal to 5, the AI model automatically takes over the voice emoji message. In this case, a display manner of a voice emoji message transmitted by a single user account in the chat interface is no longer a single voice emoji message, but changes to a merged voice emoji message. The merged voice emoji message visually senses that an emoji region becomes larger, and avatars of user accounts transmitting the messages become a collection display. A quantity of user accounts transmitting the voice emoji messages can be seen by long-pressing an avatar collection.

In some embodiments, the modeling and the sound of the merged voice emoji message may vary as a quantity of times for flooding the screen. The modeling includes at least one of a shape, a font, a color, an animation, or a decoration. The sound includes at least one of a merged sound, a changed sound (a male sound, a female sound, a cartoon sound, an animal sound, or the like), or an ambient sound (clapping, fireworks, chirping and bird call, or the like).

In some embodiments, a synthesis force parameter of the voice emoji message may be set in the social software group. When a quantity of voice emoji messages in the social software group is 5, the merged voice emoji message also changes in form under different synthesis force parameters. When the synthesis force parameter is 30%, a sound of the merged voice emoji message is a multi-person harmony synthesized from an original sound, and when the synthesis force parameter is 90%, in addition to the multi-person harmony synthesized from the original sound, an ambient sound like clapping, celebration, chirping, or bird call, is added.

In some embodiments, when the quantity of voice emoji messages in the social software group changes, under different synthesis force parameters, a display form of the merged voice emoji message also changes with both the change of a quantity of voice emoji messages and the change of the synthesis force parameter.

In some embodiments, the message merging method provided in some embodiments is cooperatively executed by the terminal and the server.

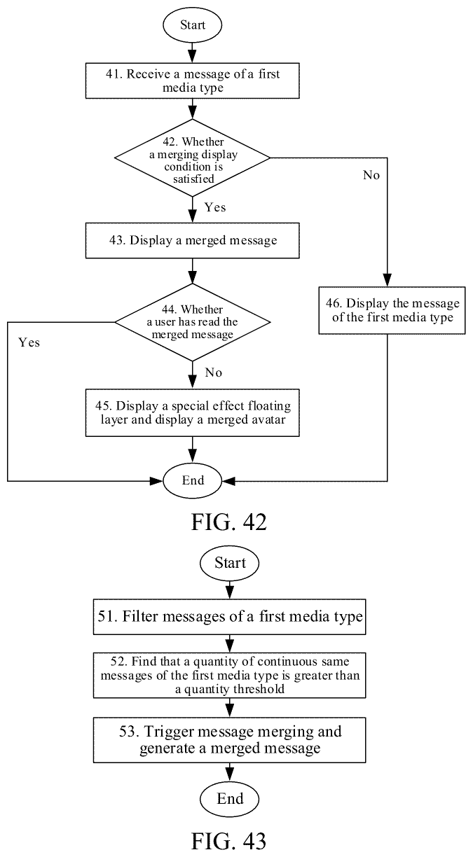

In some embodiments, as shown in FIG. 42, execution operations of the terminal include:

Operation 41: Receive a message of a first media type.

Operation 42: Determine whether a merging display condition is satisfied.

Operation 43: Display a merged message in a case that the merging display condition is satisfied.

Operation 44: Determine whether a user account has read the merged message.

Operation 45: Display a special effect floating layer and display a merged avatar in a case that the user account does not read the merged message.

Operation 46: Display the message of the first media type in a case that the merging display condition is not satisfied.

In some embodiments, as shown in FIG. 43, execution operations of the server include:

Operation 51: Filter messages of a first media type.

Operation 52: Find that a quantity of continuous same messages of the first media type is greater than a quantity threshold.

In some embodiments, it is assumed that a transmitting time of a first voice emoji message is t1, a transmitting time of a second voice emjio message is t2, and different messages are spaced from the first voice emoji message to the second voice emoji message, it may be set that voice emoji messages are continuous messages if t2−t1<3600,000 ms and a<5. When voice emoji messages accumulate to five continuous messages, merging of same voice emoji messages may be triggered and a merged voice emoji message is generated. A value of a is a positive integer.

Generally, when a similarity is greater than or equal to 90%, it may be considered that voice emoji messages are the same. For example, first picture information P1 corresponding to the first voice emoji message is obtained, and second picture information P2 corresponding to the second voice emoji message is obtained. Arrays of three color channels: red, yellow, and blue, of P1 and P2 are respectively obtained; histogram information of each channel is calculated; a contact ratio of the three color channels corresponding to P1 and P2 are respectively compared; and an average value of similarities of the three color channels is taken to obtain a similarity between the first voice emoji message and the second voice emoji message.

Operation 53: Trigger message merging and generate a merged message.

The server continuously filters and calculates whether received messages of the first media type satisfy the merging display condition. If the received messages of the first media type satisfy the merging display condition are calculated, the messages are accumulated once, until five messages are accumulated, and generation of the merged voice emoji message may be triggered.

After generating the merged voice emoji message, the server transmits the merged voice emoji message to the terminal for display. After receiving the merged voice emoji message, the terminal finds that the merged voice emoji message is a merged message, and first cancels displaying an original merged voice emoji message, and then displays the merged voice emoji message.

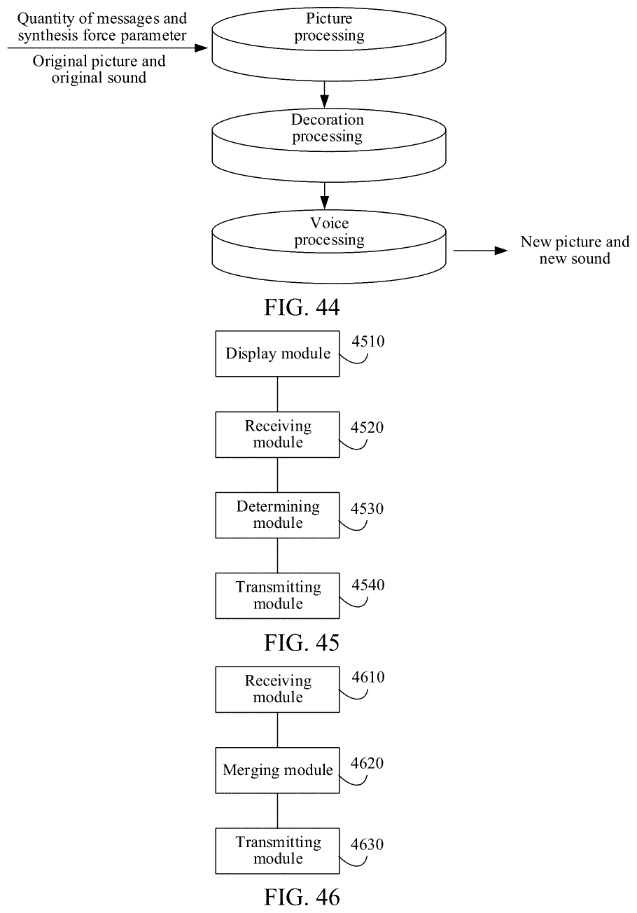

In some embodiments, as shown in FIG. 44, the message merging method provided in some embodiments is implemented based on an integral generation algorithm model. Messages of a first media type, a quantity of messages, a synthesis force parameter, an original picture, and an original sound are inputted into the generation algorithm model, and a series of processing such as picture processing, decoration processing, and voice processing is performed, to output a new picture and a new sound.

FIG. 45 is a flowchart of a message merging apparatus according to some embodiments. The apparatus includes:
a display module 4510, configured to display n messages of a first media type on a chat interface, n being a positive integer; and
a receiving module 4520, configured to receive an (n+1)^{th} message of the first media type,
the display module 4510 being further configured to merge the n+1 messages of the first media type into one merged message and display the merged message in response to the n+1 messages of the first media type satisfying a merging display condition, message content of the merged message being obtained based on merging of the n+1 messages of the first media type; and
the n+1 messages of the first media type include n messages of the first media type and the (n+1)^{th} message of the first media type.

FIG. 46 is a flowchart of a message merging apparatus according to some embodiments. The apparatus includes:
a receiving module 4610, configured to receive n+1 messages of a first media type, n being a positive integer;
a merging module 4620, configured to merge the n+1 messages of the first media type into one merged message in a case that the n+1 messages of the first media type satisfy a merging display condition, message content of the merged message being obtained based on merging of the n+1 messages of the first media type; and
a transmitting module 4630, configured to transmit the merged message to a client.

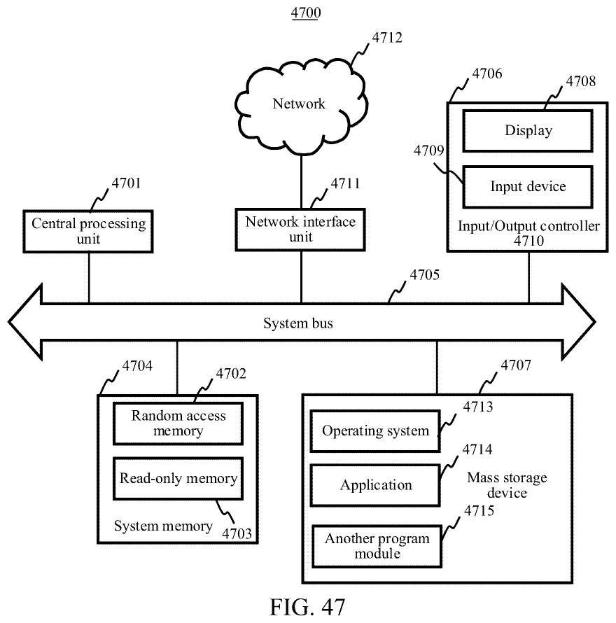

FIG. 47 is a schematic structural diagram of a computer device according to some embodiments. The computer device 4700 includes a central processing unit (CPU) 4701, a system memory 4704 including a random access memory (RAM) 4702 and a read-only memory (ROM) 4703, and a system bus 4705 connecting the system memory 4704 to the CPU 4701. The computer device 4700 further includes a basic input/output system 4706 configured to transmit information between components in the computer, and a mass storage device 4707 configured to store an operating system 4713, an application 4714, and another program module 4715.

The basic input/output system 4706 includes a display 4708 configured to display information and an input device 4709, such as a mouse or a keyboard, configured to input information for a user account. The display 4708 and the input device 4709 are both connected to the central processing unit 4701 by using an input/output controller 4710 that is connected to the system bus 4705. The basic input/output system 4706 may further include the input/output controller 4710 configured to receive and process inputs from a plurality of other devices such as a keyboard, a mouse, or an electronic stylus. Similarly, the input/output controller 4710 further provides an output to a display screen, a printer, or another type of output device.

The mass storage device 4707 is connected to the central processing unit 4701 by using a mass storage controller (not shown) connected to the system bus 4705. The mass storage device 4707 and a computer-readable medium associated with the mass storage device 4707 provide non-volatile storage for the computer device 4700. For example, the mass storage device 4707 may include a computer-readable medium (not shown) such as a hard disk or a compact disc read-only memory (CD-ROM) drive.

The computer-readable medium may include a computer storage medium and a communication medium. The computer storage medium includes volatile and non-volatile, removable and non-removable media that are configured to store information such as computer-readable instructions, data structures, program modules or other data and that are implemented by using any method or technology. The computer storage medium includes a RAM, a ROM, an erasable programmable read-only memory (EPROM), an electrically erasable programmable read-only memory (EEPROM), a flash memory or another solid-state memory technology, a CD-ROM, a digital versatile disc (DVD) or another optical memory, a tape cartridge, a magnetic cassette, a magnetic disk memory, or another magnetic storage device. Certainly, a person skilled in the art may learn that the computer storage medium is not limited to the foregoing several types. The system memory 4704 and the mass storage device 4707 may be collectively referred to as a memory.

According to some embodiments, the computer device 4700 may further be connected, through a network such as the Internet, to a remote computer on the network and run. For example, the computer device 4700 may be connected to a network 4712 by using a network interface unit 4711 connected to the system bus 4705, or may be connected to another type of network or a remote computer system (not shown) by using a network interface unit 4711.

Some embodiments further provides a computer-readable storage medium. The computer-readable storage medium has at least one program stored therein, the at least one program being loaded and executed by a processor to implement the message merging method provided in the foregoing method embodiments.

Some embodiments further provides a computer program product. The computer program product includes at least one program, the at least one program being stored in a readable storage medium; and a processor of a communication device reads signaling from the readable storage medium. The processor executes the signaling, to enable the communication device to implement the message merging method provided in the foregoing various method embodiments.

“A plurality of” mentioned in this specification means two or more. Other embodiments of this application will be apparent to a person skilled in the art from consideration of the specification and practice of this application. This application is intended to cover any variations, uses, or adaptive changes of this application. These variations, uses, or adaptive changes follow the general principles of this application and include common general knowledge or common technical means in the art, which are not disclosed in this application. The specification and the embodiments are considered as merely exemplary, and the scope and spirit of this application are pointed out in the following claims.

A person of ordinary skill in the art may understand that all or some of the operations of the foregoing embodiments may be implemented by using hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A message merging and displaying method, performed by a computer device, and the method comprising:
displaying n messages of a first media type on a chat interface, wherein n is a positive integer;
receiving an (n+1)^{th} message of the first media type;
merging, based on n+1 messages that includes the n messages and the (n+1)^{th} message satisfying a merging display condition, the n+1 messages of the first media type into a merged message; and
displaying the merged message on the chat interface.

2. The message merging and displaying method according to claim 1,
wherein the merging display condition includes:
a quantity of the n+1 messages reaches a quantity threshold, and a continuous message condition is satisfied,
wherein the continuous message condition includes:
a transmitting time interval between two adjacent messages of the first media type is less than a first threshold, and
a quantity of messages of a second media type that are between the two adjacent messages of the first media type is less than a second threshold.

3. The message merging and displaying method according to claim 1, wherein the merging comprises at least one of the following:
wherein the merging display condition further includes at least one of:
the n+1 messages are same messages;
a similarity between the n+1 messages reaching a similarity threshold; or
semantic information of the n+1 messages belongs to a same semantic type.

4. The message merging and displaying method according to claim 1, further comprising:
receiving an (n+2)^{th} message of the first media type; and
merging, based on n+2 messages that includes the n+1 messages and the (n+2)^{th} message satisfying the merging display condition, the n+2 messages into an updated merged message; and
displaying the updated merged message on the chat interface.

5. The message merging and displaying method according to claim 1, wherein the merged message includes at least one of:
visual content of the merged message that is obtained by merging visual content of the n+1 messages; or
voice content of the merged message that is obtained by merging voice content of the n+1 messages.

6. The message merging and displaying method according to claim 1, wherein the merged message includes:
a common part that is obtained by merging at least one same content item in the n+1 messages; and
a group part that is obtained by combining different content items in the n+1 messages.

7. The message merging and displaying method according to claim 1, wherein the merged message includes:
a background atmosphere part as added content that is used as a background atmosphere in addition to content of the n+1 messages.

8. The message merging and displaying method according to claim 1,
wherein a display attribute of the merged message is associated with the quantity of the n+1,
wherein the display attribute comprises at least one of the following:
a size of a display region of the merged message;
a numeral in the merged message;
a quantity of pieces of individual content in the merged message;
a quantity of decorations in the merged message;
a level of a decoration in the merged message; or
a display manner of the merged message.

9. The message merging and displaying method according to claim 1,
wherein the merged message is generated by an artificial intelligence (AI) model,
wherein a display attribute in the merged message is associated with a synthesis force parameter of the AI model, and
wherein the display attribute comprises at least one of the following:
a size of a display region of the merged message;
a numeral in the merged message;
a quantity of pieces of individual content in the merged message;
a quantity of decorations in the merged message;
a level of a decoration in the merged message; or
a display manner of the merged message.

10. The message merging and displaying method according to claim 9, further comprising:
displaying an adjustment control configured to adjust the synthesis force parameter of the AI model; and
determining the synthesis force parameter of the AI model based on a trigger operation on the adjustment control.

11. The message merging and displaying method according to claim 1, further comprising:
combining all avatars or some avatars of sender avatars of the n+1 messages; and
displaying the merged avatar based on the merged message.

12. A message merging and displaying apparatus, comprising:
at least one memory configured to store program code; and
at least one processor configured to read the program code and operate as instructed by the program code, the program code comprising:
displaying code configured to cause at least one of the at least one processor to display n messages of a first media type on a chat interface, wherein n is a positive integer;
receiving code configured to cause at least one of the at least one processor to receive an (n+1)^{th} message of the first media type;
merging code configured to cause at least one of the at least one processor to merge, based on n+1 messages that includes the n messages and the (n+1)^{th} message satisfying a merging display condition, the n+1 messages of the first media type into a merged message; and
presentation code configured to cause at least one of the at least one processor to display the merged message on the chat interface.

13. The message merging and displaying apparatus according to claim 12,
wherein the merging display condition includes:
a quantity of the n+1 messages reaches a quantity threshold, and a continuous message condition is satisfied,
wherein the continuous message condition includes:
a transmitting time interval between two adjacent messages of the first media type is less than a first threshold, and
a quantity of messages of a second media type that are between the two adjacent messages of the first media type is less than a second threshold.

14. The message merging and displaying apparatus according to claim 12,
wherein the merging display condition further includes at least one of:
the n+1 messages are same messages;
a similarity between the n+1 messages reaching a similarity threshold; or
semantic information of the n+1 messages belongs to a same semantic type.

15. The message merging and displaying apparatus according to claim 12, wherein the program code further comprises:
additional code configured to cause at least one of the at least one processor to receive an (n+2)^{th} message of the first media type; and
updating code configured to cause at least one of the at least one processor to merge, based on n+2 messages that includes the n+1 messages and the (n+2)^{th} message satisfying the merging display condition, the n+2 messages into an updated merged message; and
wherein the presentation code is further configured to cause at least one of the at least one processor to display the updated merged message on the chat interface.

16. The message merging and displaying apparatus according to claim 12, wherein the merged message includes at least one of:
visual content of the merged message that is obtained by merging visual content of the n+1 messages; or
voice content of the merged message that is obtained by merging voice content of the n+1 messages.

17. The message merging and displaying apparatus according to claim 12, wherein the merged message includes:
a common part that is obtained by merging at least one same content item in the n+1 messages; and
a group part that is obtained by combining different content items in the n+1 messages.

18. The message merging and displaying apparatus according to claim 12,
wherein a display attribute of the merged message is associated with the quantity of the n+1,
wherein the display attribute comprises at least one of the following:
a size of a display region of the merged message;
a numeral in the merged message;
a quantity of pieces of individual content in the merged message;
a quantity of decorations in the merged message;
a level of a decoration in the merged message; or
a display manner of the merged message.

19. The message merging and displaying apparatus according to claim 12,
wherein the merged message is generated by an artificial intelligence (AI) model,
wherein a display attribute in the merged message is associated with a synthesis force parameter of the AI model, and
wherein the display attribute comprises at least one of the following:
a size of a display region of the merged message;
a numeral in the merged message;
a quantity of pieces of individual content in the merged message;
a quantity of decorations in the merged message;
a level of a decoration in the merged message; or
a display manner of the merged message.

20. A non-transitory computer-readable storage medium, storing computer code which, when executed by at least one processor, causes the at least one processor to at least:
display n messages of a first media type on a chat interface, wherein n is a positive integer;
receive an (n+1)^{th} message of the first media type;
merge, based on n+1 messages that includes the n messages and the (n+1)^{th} message satisfying a merging display condition, the n+1 messages of the first media type into a merged message; and
display the merged message on the chat interface.
